(19) United States
(12) Patent Application Publication
(10) Pub. No.: US 2024/0243821 A1
(43) Pub. Date: Jul. 18, 2024

(54) NEIGHBOR CELL INTERFERENCE MEASUREMENT

(71) Applicant: QUALCOMM Incorporated, San Diego, CA (US)

(72) Inventors: Yiqing CAO, Beijing (CN); Peter GAAL, San Diego, CA (US); Bin HAN, Beijing (CN); Ting WANG, Beijing (CN); Xiao Feng WANG, San Diego, CA (US); Liangping MA, San Diego, CA (US); Alberto RICO ALVARINO, San Diego, CA (US); Yan LI, Beijing (CN); Zhimin DU, Beijing (CN); Lu GAO, Beijing (CN)

(21) Appl. No.: 18/562,269

(22) PCT Filed: Jul. 9, 2021
(86) PCT No.: PCT/CN2021/105426

§ 371 Date: Nov. 17, 2023

(51) Int. Cl. H04B 17/318; H04B 7/06; H04L 5/00; H04W 24/10; H04W 56/00

(52) U.S. Cl. CPC H04B 17/328; H04B 7/0626; H04L 5/0051; H04W 24/10; H04W 56/0015

(57) ABSTRACT

Aspects are provided which resolve neighbor beam-wise interference. A UE obtains a plurality of reference signals from each of at least one neighbor base station, where each of the reference signals is obtained in a different beam, and each of the neighbor base station(s) is in a different neighbor cell. The UE then measures a signal strength associated with each of the reference signals, and the UE indicates one or more of the reference signals to a serving base station in a serving cell, where the signal strength of each of the reference signal(s) indicated to the serving base station exceeds a threshold RSRP. After the serving base station obtains the indication from the UE, the serving base station coordinates with the neighbor base station(s) to modify one or more transmission parameters in response to the indication.

### BACKGROUND

### Technical Field

The present disclosure generally relates to communication systems, and more particularly, to a wireless communication system between a user equipment (UE) and a base station.

### Introduction

Wireless communication systems are widely deployed to provide various telecommunication services such as telephony, video, data, messaging, and broadcasts. Typical wireless communication systems may employ multiple-access technologies capable of supporting communication with multiple users by sharing available system resources. Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, and time division synchronous code division multiple access (TD-SCDMA) systems.

These multiple access technologies have been adopted in various telecommunication standards to provide a common protocol that enables different wireless devices to communicate on a municipal, national, regional, and even global level. An example telecommunication standard is 5G New Radio (NR). 5G NR is part of a continuous mobile broadband evolution promulgated by Third Generation Partnership Project (3GPP) to meet new requirements associated with latency, reliability, security, scalability (e.g., with Internet of Things (IOT)), and other requirements. 5G NR includes services associated with enhanced mobile broadband (eMBB), massive machine type communications (mMTC), and ultra-reliable low latency communications (URLLC). Some aspects of 5G NR may be based on the 4G Long Term Evolution (LTE) standard. There exists a need for further improvements in 5G NR technology. These improvements may also be applicable to other multi-access technologies and the telecommunication standards that employ these technologies.

### SUMMARY

The following presents a simplified summary of one or more aspects in order to provide a basic understanding of such aspects. This summary is not an extensive overview of all contemplated aspects, and is intended to neither identify key or critical elements of all aspects nor delineate the scope of any or all aspects. Its sole purpose is to present some concepts of one or more aspects in a simplified form as a prelude to the more detailed description that is presented later.

In an aspect of the disclosure, a method, a computer-readable medium, and an apparatus are provided. The apparatus may be a UE. The UE obtains a plurality of reference signals from each of at least one neighbor base station, where each of the reference signals is obtained in a different beam, and where each of the at least one neighbor base station is in a different neighbor cell. The UE measures a signal strength associated with each of the reference signals. The UE indicates one or more of the reference signals to a serving base station in a serving cell, where the signal strength of each of the indicated one or more of the reference signals exceeds a threshold reference signal received power (RSRP).

In an aspect of the disclosure, a method, a computer-readable medium, and an apparatus are provided. The apparatus may be a serving base station. The base station obtains, from a UE in a serving cell, an indication of one or more reference signals from each of at least one neighbor base station, where a signal strength of each of the one or more reference signals exceeds a threshold RSRP. The base station coordinates with each of the at least one neighbor base station to modify one or more transmission parameters in response to the indication.

To the accomplishment of the foregoing and related ends, the one or more aspects comprise the features hereinafter fully described and particularly pointed out in the claims. The following description and the annexed drawings set forth in detail certain illustrative features of the one or more aspects. These features are indicative, however, of but a few of the various ways in which the principles of various aspects may be employed, and this description is intended to include all such aspects and their equivalents.

### BRIEF DESCRIPTION OF THE DRAWINGS

FIG. 1 is a diagram illustrating an example of a wireless communications system and an access network.

FIG. 2A is a diagram illustrating an example of a first frame, in accordance with various aspects of the present disclosure.

FIG. 2B is a diagram illustrating an example of DL channels within a subframe, in accordance with various aspects of the present disclosure.

FIG. 2C is a diagram illustrating an example of a second frame, in accordance with various aspects of the present disclosure.

FIG. 2D is a diagram illustrating an example of UL channels within a subframe, in accordance with various aspects of the present disclosure.

FIG. 3 is a diagram illustrating an example of a base station and user equipment (UE) in an access network.

FIG. 4 is a diagram illustrating an example of a UE served by a HAPS base station and which experiences neighbor interference.

FIG. 5 are diagrams illustrating examples of a change in synchronization signal RSRP and downlink data rate over time as a result of neighbor interference.

FIG. 6 is a diagram illustrating an example of enhanced inter-cell interference coordination measures which may be applied to resolve neighbor interference.

FIG. 7 is a diagram illustrating a call flow between a UE, a serving base station, and at least one neighbor base station.

FIG. 8 is a flowchart of a method of wireless communication at a UE apparatus.

FIG. 9 is a flowchart of a method of wireless communication at a base station apparatus.

FIG. 10 is a diagram illustrating an example of a hardware implementation for an example apparatus.

FIG. 11 is a diagram illustrating another example of a hardware implementation for another example apparatus.

### DETAILED DESCRIPTION

The detailed description set forth below in connection with the appended drawings is intended as a description of various configurations and is not intended to represent the only configurations in which the concepts described herein may be practiced. The detailed description includes specific details for the purpose of providing a thorough understanding of various concepts. However, it will be apparent to those skilled in the art that these concepts may be practiced without these specific details. In some instances, well known structures and components are shown in block diagram form in order to avoid obscuring such concepts.

High altitude platform station (HAPS) systems enable broadband connectivity and telecommunication services in underserved or remote areas by providing base stations on drones, aircraft, balloons (e.g., blimps), or other locations at tropospheric or higher altitudes. As a result, HAPS systems may be subject to neighbor cell interference. For example, if a high-altitude base station (e.g., a HAPS) serves UEs within a large serving cell encompassing urban and suburban areas, the HAPS cell boundary may overlap with neighbor cells of terrestrial (grounded) base stations in the suburban area. In such case, if a UE in a HAPS serving cell moves towards the cell boundary, the UE may experience strong interference from the neighbor cells. The neighbor interference may become more severe if the HAPS is mobile (e.g., in an aircraft) since the HAPS may move towards the neighbor cells resulting in larger cell overlap areas.

One approach that base stations may apply in attempt to address neighbor interference is enhanced inter-cell interference coordination (eICIC). eICIC may provide different ways for base stations to potentially resolve neighbor interference in the frequency domain, in the time domain, or with power control. For example, the serving base station and neighbor base station(s) may attempt to resolve interference by allocating mutually exclusive downlink or uplink resource blocks (RBs), applying almost blank subframes (ABS), applying multicast broadcast single frequency network (MBSFN) subframes, applying symbol shifts, or applying home CNB (HeNB) power control.

However, while eICIC may sufficiently resolve neighbor interference in LTE deployments (e.g., using one or any combination of the above approaches), eICIC alone may not sufficiently resolve neighbor interference in NR deployments. For example, unlike in LTE deployments where a base station typically has a smaller number of antennas (e.g., 8 antennas) for coarser beamforming, in NR deployments, base stations may have a larger number of antennas (e.g., 256 antennas) for finer beamforming. Moreover, even when ABS is applied in eICIC, neighbor base station(s) may still transmit synchronization signals (e.g., in SSBs) and other reference signals with full transmission power in NR, thereby causing interference with the serving cell. As a result, neighbor base stations in NR may transmit SSBs, CSI-RS, or other reference signals with high RSRP in finer, more numerous beams than in LTE (notwithstanding eICIC), and if a UE in a serving cell is positioned in the direction of those beams, that UE may observe stronger interference from those beams than others.

Accordingly, to address the problem of strong, beam-wise neighbor interference in NR, aspects of the present disclosure allow a UE to measure a signal strength (e.g., RSRP) of reference signals received from neighbor base station(s) in different beams, determine the beams which strongly interfere with the UE (e.g., the beams carrying reference signals having a signal strength exceeding a threshold RSRP), and report an indication of these reference signals or beams to a serving base station (e.g., in a measurement report). The reference signals may be SSBs, CSI-RS, or other cell-specific reference signals (CRS) associated with a neighbor cell identifier (e.g., a physical cell identifier (PCI)). The serving base station may also provide the UE a configuration of the reference signals from the neighbor base station(s), including optionally the neighbor cell identifier(s) of the neighbor cells, and the neighbor base station(s) may transmit the reference signals to the UE according to the configuration. For example, the reference signal configuration may be a measurement object indicating the time-frequency resources, subcarrier spacing, and other information regarding each of the reference signals, and each of the reference signals may be configured in a given order by neighbor base stations (e.g., the reference signals in the configuration are ordered by neighbor cell identifier). Moreover, when providing the indication of the strongly interfering reference signals or beams to the serving base station, the UE may optionally include the neighbor cell identifier(s) of the neighbor cell(s) in this reference signal indication. For instance, the UE may omit the neighbor cell identifier(s) if the UE reports the reference signals or beams in the same order as indicated in the reference signal configuration (e.g., by neighbor cell identifier). Furthermore, in response to this indication, the serving base station may coordinate with the neighbor base station(s) to reduce the neighbor interference, either through eICIC or in some other manner. For instance, the serving base station may take action to address the interference, for example, by allocating new downlink (e.g., PDSCH) or uplink (e.g., PUSCH) resources in a grant to the UE which are mutually exclusive with the resources the neighbor base station(s) allocated for other UEs in the neighbor cells. Alternatively, the neighbor base stations may take action to address the interference, for example, by reducing transmission power of reference signals or data over the reported beam directions associated with strong interference, applying different precoding based on another precoding indicator, or changing a slot format configuration (downlink/uplink configuration) in time-division-duplexing (TDD) deployments. In this way, the neighbor cell interference may efficiently be resolved.

Several aspects of telecommunication systems will now be presented with reference to various apparatus and methods. These apparatus and methods will be described in the following detailed description and illustrated in the accompanying drawings by various blocks, components, circuits, processes, algorithms, etc. (collectively referred to as “elements”). These elements may be implemented using electronic hardware, computer software, or any combination thereof. Whether such elements are implemented as hardware or software depends upon the particular application and design constraints imposed on the overall system.

By way of example, an element, or any portion of an element, or any combination of elements may be implemented as a “processing system” that includes one or more processors. Examples of processors include microprocessors, microcontrollers, graphics processing units (GPUs), central processing units (CPUs), application processors, digital signal processors (DSPs), reduced instruction set computing (RISC) processors, systems on a chip (SoC), baseband processors, field programmable gate arrays (FPGAs), programmable logic devices (PLDs), state machines, gated logic, discrete hardware circuits, and other suitable hardware configured to perform the various functionality described throughout this disclosure. One or more processors in the processing system may execute software. Software shall be construed broadly to mean instructions, instruction sets, code, code segments, program code, programs, subprograms, software components, applications, software applications, software packages, routines, subroutines, objects, executables, threads of execution, procedures, functions, etc., whether referred to as software, firmware, middleware, microcode, hardware description language, or otherwise.

Accordingly, in one or more example embodiments, the functions described may be implemented in hardware, software, or any combination thereof. If implemented in software, the functions may be stored on or encoded as one or more instructions or code on a computer-readable medium. Computer-readable media includes computer storage media. Storage media may be any available media that can be accessed by a computer. By way of example, and not limitation, such computer-readable media can comprise a random-access memory (RAM), a read-only memory (ROM), an electrically erasable programmable ROM (EEPROM), optical disk storage, magnetic disk storage, other magnetic storage devices, combinations of the aforementioned types of computer-readable media, or any other medium that can be used to store computer executable code in the form of instructions or data structures that can be accessed by a computer.

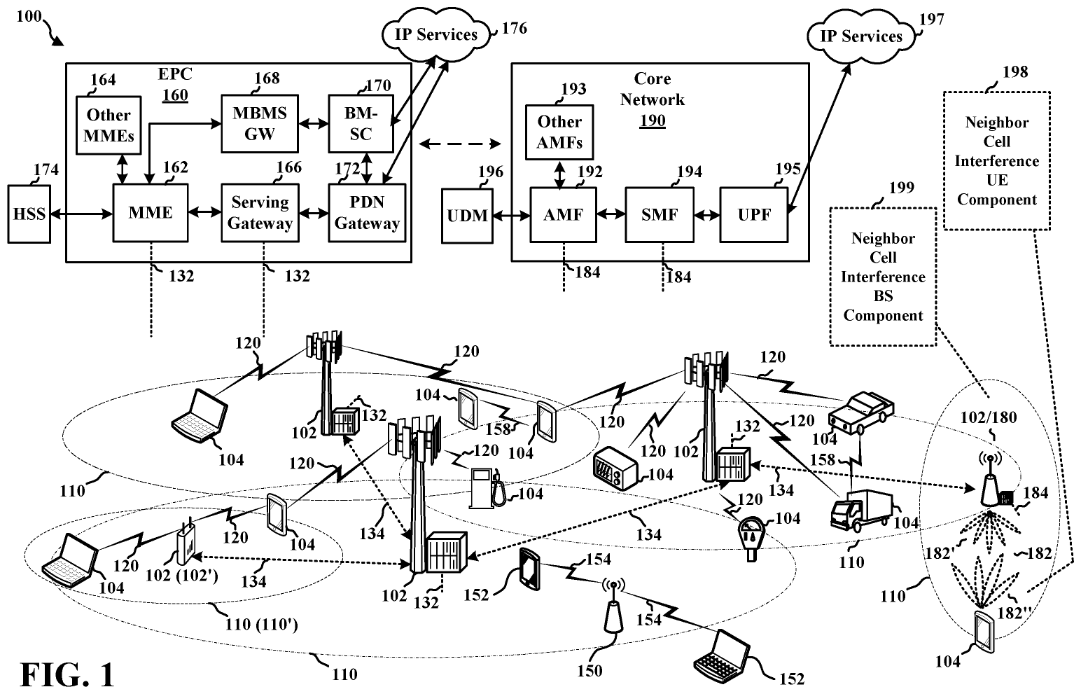

FIG. 1 is a diagram illustrating an example of a wireless communications system and an access network 100. The wireless communications system (also referred to as a wireless wide area network (WWAN)) includes base stations 102, user equipment(s) (UE) 104, an Evolved Packet Core (EPC) 160, and another core network 190 (e.g., a 5G Core (5 GC)). The base stations 102 may include macrocells (high power cellular base station) and/or small cells (low power cellular base station). The macrocells include base stations. The small cells include femtocells, picocells, and microcells.

The base stations 102 configured for 4G Long Term Evolution (LTE) (collectively referred to as Evolved Universal Mobile Telecommunications System (UMTS) Terrestrial Radio Access Network (E-UTRAN)) may interface with the EPC 160 through first backhaul links 132 (e.g., S1 interface). The base stations 102 configured for 5G New Radio (NR) (collectively referred to as Next Generation RAN (NG-RAN)) may interface with core network 190 through second backhaul links 184. In addition to other functions, the base stations 102 may perform one or more of the following functions: transfer of user data, radio channel ciphering and deciphering, integrity protection, header compression, mobility control functions (e.g., handover, dual connectivity), inter-cell interference coordination, connection setup and release, load balancing, distribution for non-access stratum (NAS) messages, NAS node selection, synchronization, radio access network (RAN) sharing, Multimedia Broadcast Multicast Service (MBMS), subscriber and equipment trace, RAN information management (RIM), paging, positioning, and delivery of warning messages. The base stations 102 may communicate directly or indirectly (e.g., through the EPC 160 or core network 190) with each other over third backhaul links 134 (e.g., X2 interface). The first backhaul links 132, the second backhaul links 184, and the third backhaul links 134 may be wired or wireless.

The base stations 102 may wirelessly communicate with the UEs 104. Each of the base stations 102 may provide communication coverage for a respective geographic coverage area 110. There may be overlapping geographic coverage areas 110. For example, the small cell 102′ may have a coverage area 110′ that overlaps the coverage area 110 of one or more macro base stations 102. A network that includes both small cell and macrocells may be known as a heterogeneous network. A heterogeneous network may also include Home Evolved Node Bs (eNBs) (HeNBs), which may provide service to a restricted group known as a closed subscriber group (CSG). The communication links 120 between the base stations 102 and the UEs 104 may include uplink (UL) (also referred to as reverse link) transmissions from a UE 104 to a base station 102 and/or downlink (DL) (also referred to as forward link) transmissions from a base station 102 to a UE 104. The communication links 120 may use multiple-input and multiple-output (MIMO) antenna technology, including spatial multiplexing, beamforming, and/or transmit diversity. The communication links may be through one or more carriers. The base stations 102/UEs 104 may use spectrum up to Y megahertz (MHz) (e.g., 5, 10, 15, 20, 100, 400, etc. MHz) bandwidth per carrier allocated in a carrier aggregation of up to a total of Yx MHz (x component carriers) used for transmission in each direction. The carriers may or may not be adjacent to each other. Allocation of carriers may be asymmetric with respect to DL and UL (e.g., more or fewer carriers may be allocated for DL than for UL). The component carriers may include a primary component carrier and one or more secondary component carriers. A primary component carrier may be referred to as a primary cell (PCell) and a secondary component carrier may be referred to as a secondary cell (SCell).

Certain UEs 104 may communicate with each other using device-to-device (D2D) communication link 158. The D2D communication link 158 may use the DL/UL WWAN spectrum. The D2D communication link 158 may use one or more sidelink channels, such as a physical sidelink broadcast channel (PSBCH), a physical sidelink discovery channel (PSDCH), a physical sidelink shared channel (PSSCH), and a physical sidelink control channel (PSCCH). D2D communication may be through a variety of wireless D2D communications systems, such as for example, WiMedia, Bluetooth, ZigBee, Wi-Fi based on the Institute of Electrical and Electronics Engineers (IEEE) 802.11 standard, LTE, or NR.

The wireless communications system may further include a Wi-Fi access point (AP) 150 in communication with Wi-Fi stations (STAs) 152 via communication links 154, e.g., in a 5 gigahertz (GHz) unlicensed frequency spectrum or the like. When communicating in an unlicensed frequency spectrum, the STAs 152/AP 150 may perform a clear channel assessment (CCA) prior to communicating in order to determine whether the channel is available.

The small cell 102′ may operate in a licensed and/or an unlicensed frequency spectrum. When operating in an unlicensed frequency spectrum, the small cell 102′ may employ NR and use the same unlicensed frequency spectrum (e.g., 5 GHZ, or the like) as used by the Wi-Fi AP 150. The small cell 102′, employing NR in an unlicensed frequency spectrum, may boost coverage to and/or increase capacity of the access network.

The electromagnetic spectrum is often subdivided, based on frequency/wavelength, into various classes, bands, channels, etc. In 5G NR, two initial operating bands have been identified as frequency range designations FR1 (410 MHz-7.125 GHZ) and FR2 (24.25 GHz-52.6 GHz). The frequencies between FR1 and FR2 are often referred to as mid-band frequencies. Although a portion of FR1 is greater than 6 GHZ, FR1 is often referred to (interchangeably) as a “sub-6 GHz” band in various documents and articles. A similar nomenclature issue sometimes occurs with regard to FR2, which is often referred to (interchangeably) as a “millimeter wave” band in documents and articles, despite being different from the extremely high frequency (EHF) band (30 GHz-300 GHz) which is identified by the International Telecommunications Union (ITU) as a “millimeter wave” band.

With the above aspects in mind, unless specifically stated otherwise, it should be understood that the term “sub-6 GHz” or the like if used herein may broadly represent frequencies that may be less than 6 GHZ, may be within FR1, or may include mid-band frequencies. Further, unless specifically stated otherwise, it should be understood that the term “millimeter wave” or the like if used herein may broadly represent frequencies that may include mid-band frequencies, may be within FR2, or may be within the EHF band.

A base station 102, whether a small cell 102′ or a large cell (e.g., macro base station), may include and/or be referred to as an eNB, gNodeB (gNB), or another type of base station. Some base stations, such as gNB 180 may operate in a traditional sub 6 GHz spectrum, in millimeter wave frequencies, and/or near millimeter wave frequencies in communication with the UE 104. When the gNB 180 operates in millimeter wave or near millimeter wave frequencies, the gNB 180 may be referred to as a millimeter wave base station. The millimeter wave base station 180 may utilize beamforming 182 with the UE 104 to compensate for the path loss and short range. The base station 180 and the UE 104 may each include a plurality of antennas, such as antenna elements, antenna panels, and/or antenna arrays to facilitate the beamforming.

The base station 180 may transmit a beamformed signal to the UE 104 in one or more transmit directions 182′. The UE 104 may receive the beamformed signal from the base station 180 in one or more receive directions 182″. The UE 104 may also transmit a beamformed signal to the base station 180 in one or more transmit directions. The base station 180 may receive the beamformed signal from the UE 104 in one or more receive directions. The base station 180/UE 104 may perform beam training to determine the best receive and transmit directions for each of the base station 180/UE 104. The transmit and receive directions for the base station 180 may or may not be the same. The transmit and receive directions for the UE 104 may or may not be the same.

The EPC 160 may include a Mobility Management Entity (MME) 162, other MMEs 164, a Serving Gateway 166, an MBMS Gateway 168, a Broadcast Multicast Service Center (BM-SC) 170, and a Packet Data Network (PDN) Gateway 172. The MME 162 may be in communication with a Home Subscriber Server (HSS) 174. The MME 162 is the control node that processes the signaling between the UEs 104 and the EPC 160. Generally, the MME 162 provides bearer and connection management. All user Internet protocol (IP) packets are transferred through the Serving Gateway 166, which itself is connected to the PDN Gateway 172. The PDN Gateway 172 provides UE IP address allocation as well as other functions. The PDN Gateway 172 and the BM-SC 170 are connected to the IP Services 176. The IP Services 176 may include the Internet, an intranet, an IP Multimedia Subsystem (IMS), a PS Streaming Service, and/or other IP services. The BM-SC 170 may provide functions for MBMS user service provisioning and delivery. The BM-SC 170 may serve as an entry point for content provider MBMS transmission, may be used to authorize and initiate MBMS Bearer Services within a public land mobile network (PLMN), and may be used to schedule MBMS transmissions. The MBMS Gateway 168 may be used to distribute MBMS traffic to the base stations 102 belonging to a Multicast Broadcast Single Frequency Network (MBSFN) arca broadcasting a particular service, and may be responsible for session management (start/stop) and for collecting eMBMS related charging information.

The core network 190 may include a Access and Mobility Management Function (AMF) 192, other AMFs 193, a Session Management Function (SMF) 194, and a User Plane Function (UPF) 195. The AMF 192 may be in communication with a Unified Data Management (UDM) 196. The AMF 192 is the control node that processes the signaling between the UEs 104 and the core network 190. Generally, the AMF 192 provides Quality of Service (QOS) flow and session management. All user IP packets are transferred through the UPF 195. The UPF 195 provides UE IP address allocation as well as other functions. The UPF 195 is connected to the IP Services 197. The IP Services 197 may include the Internet, an intranet, an IMS, a Packet Switch (PS) Streaming Service, and/or other IP services.

The base station may include and/or be referred to as a gNB, Node B, cNB, an access point, a base transceiver station, a radio base station, a radio transceiver, a transceiver function, a basic service set (BSS), an extended service set (ESS), a transmit reception point (TRP), or some other suitable terminology. The base station 102 provides an access point to the EPC 160 or core network 190 for a UE 104. Examples of UEs 104 include a cellular phone, a smart phone, a session initiation protocol (SIP) phone, a laptop, a personal digital assistant (PDA), a satellite radio, a global positioning system, a multimedia device, a video device, a digital audio player (e.g., MP3 player), a camera, a game console, a tablet, a smart device, a wearable device, a vehicle, an electric meter, a gas pump, a large or small kitchen appliance, a healthcare device, an implant, a sensor/actuator, a display, or any other similar functioning device. Some of the UEs 104 may be referred to as IoT devices (e.g., parking meter, gas pump, toaster, vehicles, heart monitor, etc.). The UE 104 may also be referred to as a station, a mobile station, a subscriber station, a mobile unit, a subscriber unit, a wireless unit, a remote unit, a mobile device, a wireless device, a wireless communications device, a remote device, a mobile subscriber station, an access terminal, a mobile terminal, a wireless terminal, a remote terminal, a handset, a user agent, a mobile client, a client, or some other suitable terminology.

Although the present disclosure may focus on 5G NR, the concepts and various aspects described herein may be applicable to other similar areas, such as LTE, LTE-Advanced (LTE-A), Code Division Multiple Access (CDMA), Global System for Mobile communications (GSM), or other wireless/radio access technologies.

Referring again to FIG. 1, in certain aspects, the UE 104 may include a neighbor cell interference UE component 198 that is configured to obtain a plurality of reference signals from each of at least one neighbor base station, where each of the reference signals is obtained in a different beam, and where each of the at least one neighbor base station is in a different neighbor cell; measure a signal strength associated with each of the reference signals; and indicate one or more of the reference signals to a serving base station in a serving cell, where the signal strength of each of the indicated one or more of the reference signals exceeds a threshold RSRP.

Referring again to FIG. 1, in certain aspects, the base station 180 may include a neighbor cell interference BS component 199 that is configured to obtain, from a UE in a serving cell, an indication of one or more reference signals from each of at least one neighbor base station, where a signal strength of each of the one or more reference signals exceeds a threshold RSRP; and coordinating with each of the at least one neighbor base station to modify one or more transmission parameters in response to the indication.

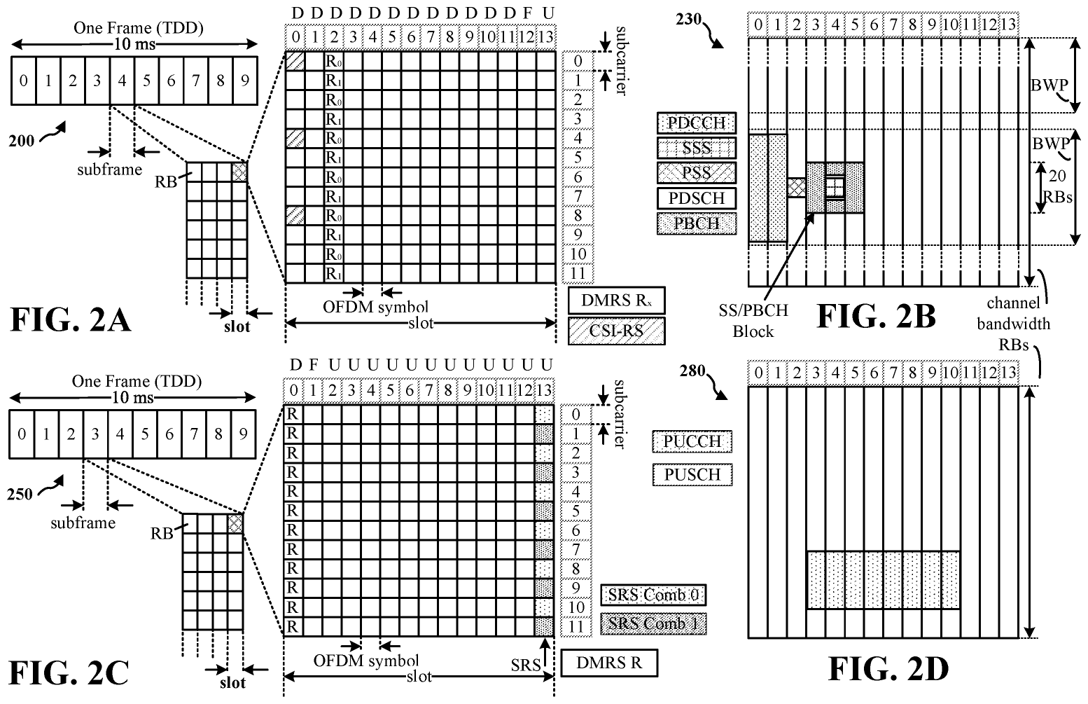

FIG. 2A is a diagram 200 illustrating an example of a first subframe within a 5G NR frame structure. FIG. 2B is a diagram 230 illustrating an example of DL channels within a 5G NR subframe. FIG. 2C is a diagram 250 illustrating an example of a second subframe within a 5G NR frame structure. FIG. 2D is a diagram 280 illustrating an example of UL channels within a 5G NR subframe. The 5G NR frame structure may be frequency division duplexed (FDD) in which for a particular set of subcarriers (carrier system bandwidth), subframes within the set of subcarriers are dedicated for either DL or UL, or may be time division duplexed (TDD) in which for a particular set of subcarriers (carrier system bandwidth), subframes within the set of subcarriers are dedicated for both DL and UL. In the examples provided by FIGS. 2A, 2C, the 5G NR frame structure is assumed to be TDD, with subframe 4 being configured with slot format 28 (with mostly DL), where D is DL, U is UL, and F is flexible for use between DL/UL, and subframe 3 being configured with slot format 34 (with mostly UL). While subframes 3, 4 are shown with slot formats 34, 28, respectively, any particular subframe may be configured with any of the various available slot formats 0-61. Slot formats 0, 1 are all DL, UL, respectively. Other slot formats 2-61 include a mix of DL, UL, and flexible symbols. UEs are configured with the slot format (dynamically through DL control information (DCI), or semi-statically/statically through radio resource control (RRC) signaling) through a received slot format indicator (SFI). Note that the description infra applies also to a 5G NR frame structure that is TDD.

Other wireless communication technologies may have a different frame structure and/or different channels. A frame, e.g., of 10 milliseconds (ms), may be divided into 10 equally sized subframes (1 ms). Each subframe may include one or more time slots. Subframes may also include mini-slots, which may include 7, 4, or 2 symbols. Each slot may include 7 or 14 symbols, depending on the slot configuration. For slot configuration 0, each slot may include 14 symbols, and for slot configuration 1, each slot may include 7 symbols. The symbols on DL may be cyclic prefix (CP) orthogonal frequency-division multiplexing (OFDM) (CP-OFDM) symbols. The symbols on UL may be CP-OFDM symbols (for high throughput scenarios) or discrete Fourier transform (DFT) spread OFDM (DFT-s-OFDM) symbols (also referred to as single carrier frequency-division multiple access (SC-FDMA) symbols) (for power limited scenarios; limited to a single stream transmission). The number of slots within a subframe is based on the slot configuration and the numerology. For slot configuration 0, different numerologies μ 0 to 4 allow for 1, 2, 4, 8, and 16 slots, respectively, per subframe. For slot configuration 1, different numerologies 0 to 2 allow for 2, 4, and 8 slots, respectively, per subframe. Accordingly, for slot configuration 0 and numerology μ, there are 14 symbols/slot and 2^{μ} slots/subframe. The subcarrier spacing and symbol length/duration are a function of the numerology. The subcarrier spacing may be equal to 2^{μ}*15 kilohertz (kHz), where u is the numerology 0 to 4. As such, the numerology μ=0 has a subcarrier spacing of 15 kHz and the numerology μ=4 has a subcarrier spacing of 240 kHz. The symbol length/duration is inversely related to the subcarrier spacing. FIGS. 2A-2D provide an example of slot configuration 0 with 14 symbols per slot and numerology μ=2 with 4 slots per subframe. The slot duration is 0.25 ms, the subcarrier spacing is 60 kHz, and the symbol duration is approximately 16.67 μs. Within a set of frames, there may be one or more different bandwidth parts (BWPs) (see FIG. 2B) that are frequency division multiplexed. Each BWP may have a particular numerology.

A resource grid may be used to represent the frame structure. Each time slot includes a resource block (RB) (also referred to as physical RBs (PRBs)) that extends 12 consecutive subcarriers. The resource grid is divided into multiple resource elements (REs). The number of bits carried by each RE depends on the modulation scheme.

As illustrated in FIG. 2A, some of the REs carry reference (pilot) signals (RS) for the UE. The RS may include demodulation RS (DM-RS) (indicated as Rx for one particular configuration, where 100× is the port number, but other DM-RS configurations are possible) and channel state information reference signals (CSI-RS) for channel estimation at the UE. The RS may also include beam measurement RS (BRS), beam refinement RS (BRRS), and phase tracking RS (PT-RS).

FIG. 2B illustrates an example of various DL channels within a subframe of a frame. The physical downlink control channel (PDCCH) carries DCI within one or more control channel elements (CCEs), each CCE including nine RE groups (REGs), each REG including four consecutive REs in an OFDM symbol. A PDCCH within one BWP may be referred to as a control resource set (CORESET). Additional BWPs may be located at greater and/or lower frequencies across the channel bandwidth. A primary synchronization signal (PSS) may be within symbol 2 of particular subframes of a frame. The PSS is used by a UE 104 to determine subframe/symbol timing and a physical layer identity. A secondary synchronization signal (SSS) may be within symbol 4 of particular subframes of a frame. The SSS is used by a UE to determine a physical layer cell identity group number and radio frame timing. Based on the physical layer identity and the physical layer cell identity group number, the UE can determine a physical cell identifier (PCI). Based on the PCI, the UE can determine the locations of the aforementioned DM-RS. The physical broadcast channel (PBCH), which carries a master information block (MIB), may be logically grouped with the PSS and SSS to form a synchronization signal (SS)/PBCH block (also referred to as SS block (SSB)). The MIB provides a number of RBs in the system bandwidth and a system frame number (SFN). The physical downlink shared channel (PDSCH) carries user data, broadcast system information not transmitted through the PBCH such as system information blocks (SIBs), and paging messages.

As illustrated in FIG. 2C, some of the REs carry DM-RS (indicated as R for one particular configuration, but other DM-RS configurations are possible) for channel estimation at the base station. The UE may transmit DM-RS for the physical uplink control channel (PUCCH) and DM-RS for the physical uplink shared channel (PUSCH). The PUSCH DM-RS may be transmitted in the first one or two symbols of the PUSCH. The PUCCH DM-RS may be transmitted in different configurations depending on whether short or long PUCCHs are transmitted and depending on the particular PUCCH format used. The UE may transmit sounding reference signals (SRS). The SRS may be transmitted in the last symbol of a subframe. The SRS may have a comb structure, and a UE may transmit SRS on one of the combs. The SRS may be used by a base station for channel quality estimation to enable frequency-dependent scheduling on the UL.

FIG. 2D illustrates an example of various UL channels within a subframe of a frame. The PUCCH may be located as indicated in one configuration. The PUCCH carries uplink control information (UCI), such as scheduling requests, a channel quality indicator (CQI), a precoding matrix indicator (PMI), a rank indicator (RI), and hybrid automatic repeat request (HARQ) acknowledgement (ACK)/non-acknowledgement (NACK) feedback. The PUSCH carries data, and may additionally be used to carry a buffer status report (BSR), a power headroom report (PHR), and/or UCI.

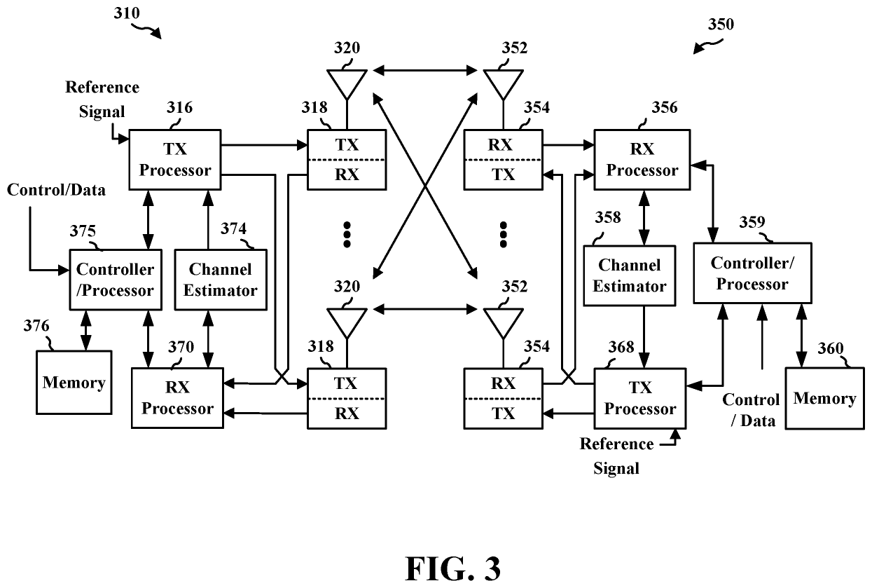

FIG. 3 is a block diagram of a base station 310 in communication with a UE 350 in an access network. In the DL, IP packets from the EPC 160 may be provided to a controller/processor 375. The controller/processor 375 implements layer 3 and layer 2 functionality. Layer 3 includes a radio resource control (RRC) layer, and layer 2 includes a service data adaptation protocol (SDAP) layer, a packet data convergence protocol (PDCP) layer, a radio link control (RLC) layer, and a medium access control (MAC) layer. The controller/processor 375 provides RRC layer functionality associated with broadcasting of system information (e.g., MIB, SIBs), RRC connection control (e.g., RRC connection paging, RRC connection establishment, RRC connection modification, and RRC connection release), inter radio access technology (RAT) mobility, and measurement configuration for UE measurement reporting; PDCP layer functionality associated with header compression/decompression, security (ciphering, deciphering, integrity protection, integrity verification), and handover support functions; RLC layer functionality associated with the transfer of upper layer packet data units (PDUs), error correction through ARQ, concatenation, segmentation, and reassembly of RLC service data units (SDUs), re-segmentation of RLC data PDUs, and reordering of RLC data PDUs; and MAC layer functionality associated with mapping between logical channels and transport channels, multiplexing of MAC SDUs onto transport blocks (TBs), demultiplexing of MAC SDUs from TBs, scheduling information reporting, error correction through HARQ, priority handling, and logical channel prioritization.

The transmit (TX) processor 316 and the receive (RX) processor 370 implement layer 1 functionality associated with various signal processing functions. Layer 1, which includes a physical (PHY) layer, may include error detection on the transport channels, forward error correction (FEC) coding/decoding of the transport channels, interleaving, rate matching, mapping onto physical channels, modulation/demodulation of physical channels, and MIMO antenna processing. The TX processor 316 handles mapping to signal constellations based on various modulation schemes (e.g., binary phase-shift keying (BPSK), quadrature phase-shift keying (QPSK), M-phase-shift keying (M-PSK), M-quadrature amplitude modulation (M-QAM)). The coded and modulated symbols may then be split into parallel streams. Each stream may then be mapped to an OFDM subcarrier, multiplexed with a reference signal (e.g., pilot) in the time and/or frequency domain, and then combined together using an Inverse Fast Fourier Transform (IFFT) to produce a physical channel carrying a time domain OFDM symbol stream. The OFDM stream is spatially precoded to produce multiple spatial streams. Channel estimates from a channel estimator 374 may be used to determine the coding and modulation scheme, as well as for spatial processing. The channel estimate may be derived from a reference signal and/or channel condition feedback transmitted by the UE 350. Each spatial stream may then be provided to a different antenna 320 via a separate transmitter 318TX. Each transmitter 318TX may modulate an RF carrier with a respective spatial stream for transmission.

At the UE 350, each receiver 354RX receives a signal through its respective antenna 352. Each receiver 354RX recovers information modulated onto an RF carrier and provides the information to the receive (RX) processor 356. The TX processor 368 and the RX processor 356 implement layer 1 functionality associated with various signal processing functions. The RX processor 356 may perform spatial processing on the information to recover any spatial streams destined for the UE 350. If multiple spatial streams are destined for the UE 350, they may be combined by the RX processor 356 into a single OFDM symbol stream. The RX processor 356 then converts the OFDM symbol stream from the time-domain to the frequency domain using a Fast Fourier Transform (FFT). The frequency domain signal comprises a separate OFDM symbol stream for each subcarrier of the OFDM signal. The symbols on each subcarrier, and the reference signal, are recovered and demodulated by determining the most likely signal constellation points transmitted by the base station 310. These soft decisions may be based on channel estimates computed by the channel estimator 358. The soft decisions are then decoded and deinterleaved to recover the data and control signals that were originally transmitted by the base station 310 on the physical channel. The data and control signals are then provided to the controller/processor 359, which implements layer 3 and layer 2 functionality.

The controller/processor 359 can be associated with a memory 360 that stores program codes and data. The memory 360 may be referred to as a computer-readable medium. In the UL, the controller/processor 359 provides demultiplexing between transport and logical channels, packet reassembly, deciphering, header decompression, and control signal processing to recover IP packets from the EPC 160. The controller/processor 359 is also responsible for error detection using an ACK and/or NACK protocol to support HARQ operations.

Similar to the functionality described in connection with the DL transmission by the base station 310, the controller/processor 359 provides RRC layer functionality associated with system information (e.g., MIB, SIBs) acquisition, RRC connections, and measurement reporting; PDCP layer functionality associated with header compression/decompression, and security (ciphering, deciphering, integrity protection, integrity verification); RLC layer functionality associated with the transfer of upper layer PDUs, error correction through ARQ, concatenation, segmentation, and reassembly of RLC SDUs, re-segmentation of RLC data PDUs, and reordering of RLC data PDUs; and MAC layer functionality associated with mapping between logical channels and transport channels, multiplexing of MAC SDUs onto TBs, demultiplexing of MAC SDUs from TBs, scheduling information reporting, error correction through HARQ, priority handling, and logical channel prioritization.

Channel estimates derived by a channel estimator 358 from a reference signal or feedback transmitted by the base station 310 may be used by the TX processor 368 to select the appropriate coding and modulation schemes, and to facilitate spatial processing. The spatial streams generated by the TX processor 368 may be provided to different antenna 352 via separate transmitters 354TX. Each transmitter 354TX may modulate an RF carrier with a respective spatial stream for transmission.

The UL transmission is processed at the base station 310 in a manner similar to that described in connection with the receiver function at the UE 350. Each receiver 318RX receives a signal through its respective antenna 320. Each receiver 318RX recovers information modulated onto an RF carrier and provides the information to a RX processor 370.

The controller/processor 375 can be associated with a memory 376 that stores program codes and data. The memory 376 may be referred to as a computer-readable medium. In the UL, the controller/processor 375 provides demultiplexing between transport and logical channels, packet reassembly, deciphering, header decompression, control signal processing to recover IP packets from the UE 350. IP packets from the controller/processor 375 may be provided to the EPC 160. The controller/processor 375 is also responsible for error detection using an ACK and/or NACK protocol to support HARQ operations.

At least one of the TX processor 368, the RX processor 356, and the controller/processor 359 may be configured to perform aspects in connection with neighbor cell interference UE component 198 of FIG. 1.

At least one of the TX processor 316, the RX processor 370, and the controller/processor 375 may be configured to perform aspects in connection with neighbor cell interference BS component 199 of FIG. 1.

HAPS systems enable broadband connectivity and telecommunication services in underserved or remote areas by providing base stations on drones, aircraft, balloons (e.g., blimps), or other locations at tropospheric or higher altitudes. As a result, HAPS systems may be subject to neighbor cell interference. For example, if a high-altitude base station (e.g., a HAPS) serves UEs within a large serving cell encompassing urban and suburban areas, the HAPS cell boundary may overlap with neighbor cells of terrestrial (grounded) base stations in the suburban area. In such case, if a UE in a HAPS serving cell moves towards the cell boundary, the UE may experience strong interference from the neighbor cells. The neighbor interference may become more severe if the HAPS is mobile (e.g., in an aircraft) since the HAPS may move towards the neighbor cells resulting in larger cell overlap areas.

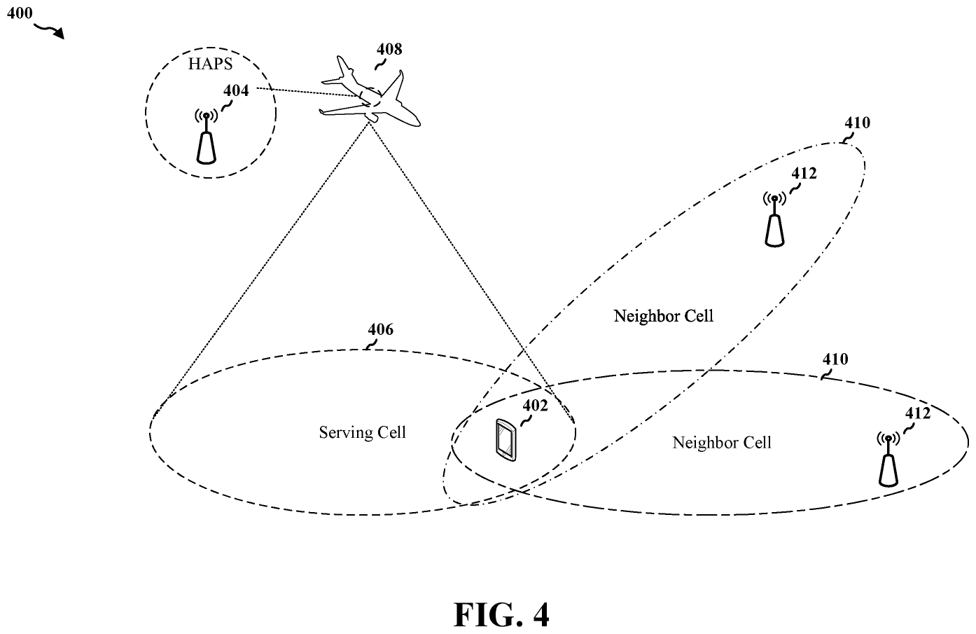

FIG. 4 illustrates an example 400 of a UE 402 served by a HAPS 404 in a serving cell 406. The HAPS may be in or on an aircraft 408 such as illustrated in FIG. 4; alternatively, the HAPS may be in or on a drone, a balloon (blimp), or at some other high altitude location. The serving cell 406 of the HAPS may overlap with one or more neighbor cells 410 of neighbor base stations 412 (e.g., terrestrial base stations). For example, the serving cell 406 may movably encompass an urban and suburban area (e.g., due to motion of aircraft 408), while the neighbor cells 410 may be deployed within the suburban area. As a result, if the UE 402 is located at the cell boundary of serving cell 406 (e.g., in a suburban area), the UE may experience neighbor interference from the neighbor base stations 412, which in turn, may result in rapid degradation of HAPS data throughput.

For instance, when the HAPS 404 transmits data to the UE 402 in serving cell 406, the UE may fail to receive or decode the data due to data transmissions in the neighbor cells 410, and the UE may consequently inform the HAPS of the failure via non-acknowledgment (NACK). For example, at least one of the neighbor base stations 412 may transmit data to one or more other UEs (not shown) in the neighbor cells 410, which data may be carried in transmission beams having beam direction(s) overlapping with the position of UE 402. These transmissions (e.g., in certain beams) may interfere with communications between the UE 402 and the HAPS 404 in serving cell 406, causing the UE 402 to experience reception or decoding failures multiple times and subsequently send multiple NACKs to the HAPS. In response to the NACKs, the HAPS 404 may decrease data rates significantly in attempt to improve the likelihood of successful UE reception or decoding, even though the reference signal received power (RSRP) of data from the serving base station may remain relatively constant.

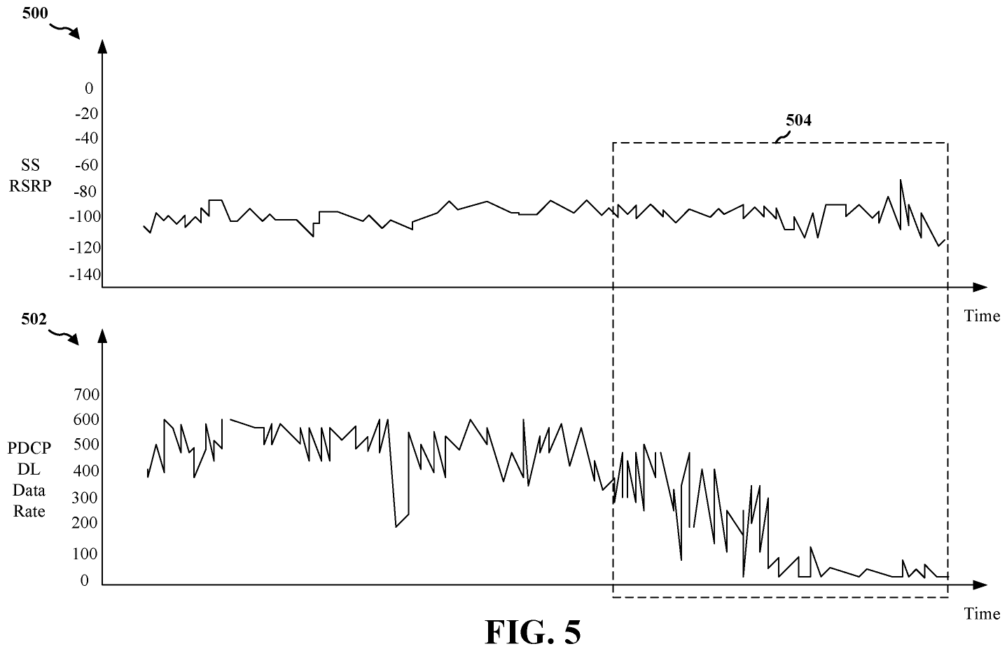

FIG. 5 illustrates examples of graphs 500, 502 respectively showing changes in synchronization signal RSRP and downlink data rate over time as a result of neighbor interference (e.g., by neighbor base stations 412). Prior to the time encompassed in window 504, the UE (e.g., UE 402) may be within the center of the HAPS serving cell (e.g., serving cell 406), and therefore the RSRP of synchronization signals from the HAPS (e.g., SSBs) may be relatively strong and the packet data convergence protocol (PDCP) downlink data rate may be relatively high. However, once the UE begins experiencing interference from neighbor cells (e.g., neighbor cells 410) within the time encompassed in window 504 (e.g., after moving to a cell boundary of serving cell 406), the PDCP downlink data rate may rapidly degrade. For example, the data rate may significantly drop as a result of multiple NACKs caused by the neighbor interference such as described above with respect to FIG. 4. In contrast, the RSRP of the data from the serving base station may remain at similar levels, such as illustrated in FIG. 5.

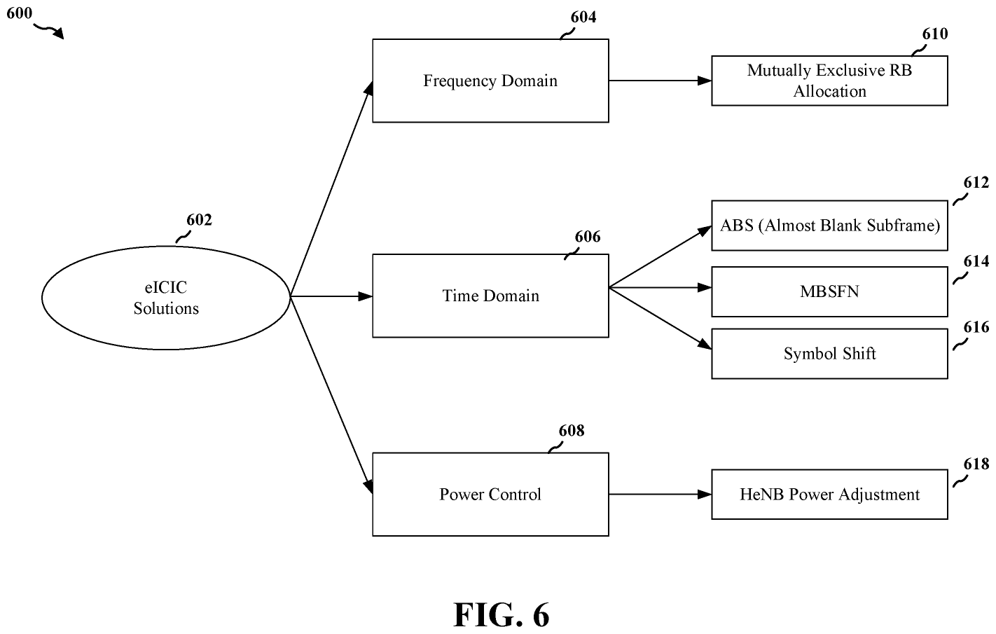

One approach that base stations may apply in attempt to address neighbor interference is enhanced inter-cell interference coordination (cICIC). FIG. 6 illustrates an example 600 of eICIC solutions 602 which provide different ways for base stations to potentially resolve neighbor interference in the frequency domain (e.g., at block 604), in the time domain (e.g., at block 606), or with power control (e.g., at block 608). For example, in the frequency domain, the serving base station and neighbor base station(s) may resolve interference by allocating mutually exclusive downlink or uplink resource blocks (RBs) (e.g., at block 610). For example, at block 610, the serving base station may allocate RBs for communication with a UE which are different than the RBs in which the neighbor base station(s) communicate with other UEs. In another example, in the time domain, the serving and neighbor base station(s) may resolve interference by applying almost blank subframes (ABS) (e.g., at block 612), multicast broadcast single frequency network (MBSFN) subframes (e.g., at block 614), or symbol shifts (e.g., at block 616). For example, at block 612, the neighbor base station may reduce transmission power of certain subframes (e.g., ABS) during which time the serving base station may communicate data with the UE, at block 614, the neighbor base station may communicate data in MBSFN subframes during the times that the serving base station communicates data with the UE, or at block 616, the neighbor base station may shift its data transmissions by a number of symbols with respect to the data transmissions of the serving base station. In a further example, the serving and neighbor base station(s) may resolve interference by applying home eNB (HeNB) power control (e.g., at block 618). For example, at block 618, neighbor base stations which are HeNBs (e.g., in femtocells) may reduce their transmission power in order to reduce interference with the serving base station.

However, while eICIC may sufficiently resolve neighbor interference in LTE deployments, eICIC alone may not sufficiently resolve neighbor interference in NR deployments. For example, unlike in LTE deployments where a base station typically has a smaller number of antennas (e.g., 8 antennas) for coarser beamforming, in NR deployments, base stations may have a larger number of antennas (e.g., 256 antennas) for finer beamforming. Moreover, even when ABS is applied in eICIC, neighbor base station(s) may still transmit synchronization signals (e.g., in SSBs) and other reference signals with full transmission power in NR. thereby causing interference with the serving cell. As a result, neighbor base stations in NR may transmit SSBs, CSI-RS, or other reference signals with high RSRP in finer, more numerous beams than in LTE (notwithstanding cICIC), and if a UE in a serving cell is positioned in the direction of those beams, that UE may observe stronger interference from those beams than others.

Accordingly, to address the problem of strong, beam-wise neighbor interference in NR, aspects of the present disclosure allow a UE to measure a signal strength (e.g., RSRP) of reference signals received from neighbor base station(s) in different beams, determine the beams which strongly interfere with the UE (e.g., the beams carrying reference signals having a signal strength exceeding a threshold RSRP), and report an indication of these reference signals or beams to a serving base station (e.g., in a measurement report). The reference signals may be SSBs, CSI-RS, or other cell-specific reference signals (CRS) associated with a neighbor cell identifier (e.g., a physical cell identifier (PCI)). The serving base station may also provide the UE a configuration of the reference signals from the neighbor base station(s), including optionally the neighbor cell identifier(s) of the neighbor cells, and the neighbor base station(s) may transmit the reference signals to the UE according to the configuration. For example, the reference signal configuration may be a measurement object indicating the time-frequency resources, subcarrier spacing, and other information regarding each of the reference signals, and each of the reference signals may be configured in a given order by neighbor base stations (e.g., the reference signals in the configuration are ordered by neighbor cell identifier). Moreover, when providing the indication of the strongly interfering reference signals or beams to the serving base station, the UE may optionally include the neighbor cell identifier(s) of the neighbor cell(s) in this reference signal indication. For instance, the UE may omit the neighbor cell identifier(s) if the UE reports the reference signals or beams in the same order as indicated in the reference signal configuration (e.g., by neighbor cell identifier). Furthermore, in response to this indication, the serving base station may coordinate with the neighbor base station(s) to reduce the neighbor interference, either through eICIC or in some other manner. For instance, the serving base station may take action to address the interference, for example, by allocating new downlink (e.g., PDSCH) or uplink (e.g., PUSCH) resources in a grant to the UE which are mutually exclusive with the resources the neighbor base station(s) allocated for other UEs in the neighbor cells. Alternatively, the neighbor base stations may take action to address the interference, for example, by reducing transmission power of reference signals or data over the reported beam directions associated with strong interference, applying different precoding based on another precoding indicator, or changing a slot format configuration (downlink/uplink configuration) in time-division-duplexing (TDD) deployments. In this way, the neighbor cell interference may efficiently be resolved.

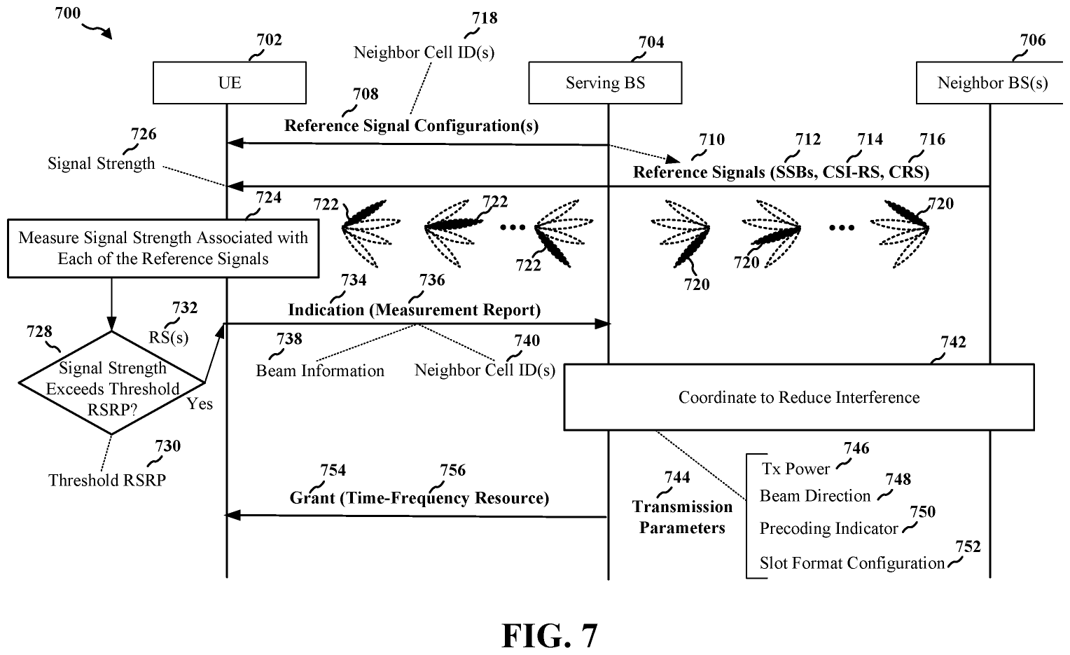

FIG. 7 is an example 700 of a call flow between a UE 702, a serving base station 704, and at least one neighbor base station 706. UE 702 may correspond to UE 402 in FIG. 4, serving base station 704 may correspond to HAPS 404 in FIG. 4 (or some other base station other than a HAPS), and the neighbor base station(s) 706 may correspond to neighbor base station(s) 412 in FIG. 4.

Initially, the serving base station 704 may send a reference signal configuration 708 (or multiple reference signal configurations) to the UE 702. The reference signal configuration(s) 708 may indicate information pertaining to reference signals 710 from the neighbor base station(s) 706. For example, reference signal configuration 708 may be or include one or more measurement objects indicating time-frequency resources, subcarrier spacing, or other information of SSBs 712, CSI-RS 714, CRS 716, or other reference signals from the neighbor base station(s) 706. In one example, the serving base station 704 may configure the information in reference signal configuration(s) 708. In another example, the neighbor base station(s) 706 may configure the information in reference signal configuration(s) 708, and the serving base station 704 may receive the information included in the reference signal configuration(s) from the neighbor base station(s) 706.

The reference signal configuration 708 may also indicate a neighbor cell identifier 718 of each of the neighbor base stations that transmit reference signals 710. For example, the reference signal configuration 708 may indicate reference signals from multiple neighbor base stations, and each of the configured reference signals in the reference signal configuration 708 may be associated with a PCI of the corresponding neighbor cell. Alternatively, the serving base station may send multiple reference signal configurations 708, one for each neighbor cell. Moreover, the reference signals may be configured in order according to the neighbor cell identifier 718. For instance, the serving base station may send a reference signal configuration for each neighbor cell, or indicate the reference signals for each neighbor cell in the same reference signal configuration, in either ascending or descending order of PCI. For example, if two neighbor base stations respectively associated with PCIs 1 and 2 (or some other PCI values) are each configured to transmit 256 reference signals over individual beams (or some other number), the serving base station may first indicate the configuration of the 256 reference signals from the first neighbor base station associated with PCI 1 followed by the configuration of the next 256 reference signals from the second neighbor base station associated with PCI 2. These configurations may be part of the same reference signal configuration 708 (e.g., a same measurement object) or in separate reference signal configurations (e.g., different measurement objects).

Afterwards, the neighbor base station(s) 706 may send reference signals 710 (e.g., SSBs 712, CSI-RS 714, CRS 716, etc.) to UE 702. Each of the neighbor base station(s) 706 may send reference signals 710 to the UE 702 respectively in different transmission beams 720, and the UE may obtain the reference signals from the neighbor base station(s) respectively in different reception beams 722. For example, the neighbor base station(s) 706 may each transmit multiple reference signals respectively over corresponding transmission beams to the UE (e.g., one reference signal in one transmission beam, another reference signal in another transmission beam, etc.), where the transmission beams 720 of one neighbor base station may be the same as, or different than, the transmission beams 720 of another neighbor base station. Similarly, the UE 702 may receive the multiple reference signals respectively over corresponding reception beams from each of the neighbor base station(s) (e.g., one reference signal in one reception beam, another reference signal in another reception beam, etc.), where the reception beams 722 for one neighbor base station may be the same as, or different than, the reception beams 722 for a different neighbor base station. The UE 702 may ascertain the source of a reference signal, namely the originating neighbor base station, based on the reference signal configuration(s) 708 (e.g., the neighbor cell identifier 718 associated with each reference signal 710 or the received order of reference signals 710 indicated in the configuration(s)), the reception beam in which the reference signal was obtained, or other information.

Upon receiving each of the reference signals 710 from one or more of the neighbor base station(s) 706, at block 724, the UE 702 may measure a signal strength 726 associated with each of the reference signals. For instance, the UE 702 may determine a RSRP of each of the reference signals 710 received in the different reception beams 722. The UE 702 may also check, at block 728, whether the measured signal strength for each reference signal 710 exceeds a threshold RSRP 730. If the UE determines any of the reference signals 710 received over reception beams 722 exceeds the threshold RSRP 730, the UE 702 may identify these reference signals 732 or reception beams (and corresponding transmission beams) of high signal strength as being associated with strong neighbor interference, and the UE send an indication 734 of these reference signals 732 to the serving base station 704 accordingly. For instance, the UE 702 may transmit a measurement report 736 (e.g., a channel state information (CSI) report or another report) to the serving base station informing the base station of the measurement results obtained at block 724. For example, the indication 734 (e.g., measurement report 736) may include beam information 738 indicating the beam direction, angle, or other information of each reception beam 722 in which strong neighbor interference was detected (e.g., in which reference signals 732 were carried having signal strengths 726 exceeding the threshold RSRP 730).

In one example, the UE may include in indication 734 (e.g., in measurement report 736) a neighbor cell identifier 740 associated with each of the neighbor base station(s) 706 causing strong neighbor interference. For example, the measurement results may include the PCIs for each of the neighbor cells where reference signals 732 were identified as having signal strengths 726 exceeding the threshold RSRP 730. The neighbor cell identifiers 740 may also be associated with the beam information 738 in the measurement report 736 to help the serving base station determine which neighbor base station(s) 706 and beam(s) together caused the reported interference. Alternatively, in another example, the UE may omit including neighbor cell identifier 740 in the indication 734. For example, in some cases, the UE may report beam information 738 in measurement report 736 in the same order of neighbor cell identifiers as the reference signals 710 indicated in the reference signal configuration(s) 708. In such case, the serving base station may determine from the reference signal configuration(s) alone which neighbor base station(s) 706 and beam(s) together caused the reported interference, and thus the UE may simplify the reporting by refraining from including associated neighbor cell identifiers in the measurement report 736.

For example, if reference signal configuration 708 indicated the configuration of 256 reference signals from a first neighbor base station associated with PCI 1 followed by the configuration of 256 reference 710 from a second neighbor base station associated with PCI 2 such as described above, and if the UE orders information in measurement report 736 such that beam information 738 for reference signals 732 originating from the first neighbor base station precedes beam information 738 for reference signals 732 originating from the second neighbor base station, the UE may omit reference to the PCIs in measurement report 736. The UE may refrain from including the neighbor cell identifiers 740 in this example since the order of beam information 738 in the measurement report 736 coincides with the order of reference signals or neighbor cell identifiers in the reference signal configuration(s) 708. Alternatively, if the UE orders information in measurement report 736 such that beam information 738 for reference signals 732 originating from the second neighbor base station precedes beam information 738 for reference signals 732 originating from the first neighbor base station, the UE may include the PCI associated with each beam information 738 in the measurement report. Here, the UE reports associated neighbor cell identifiers since, in this example, the order of beam information 738 in the measurement report 736 does not coincide with (e.g., is different from) the order of reference signals or neighbor cell identifiers in the reference signal configuration(s) 708.

Following receipt of the indication 734 (e.g., measurement report 736) from UE 702, at block 742, the serving base station 704 may coordinate with the neighbor base station(s) 706 to modify one or more transmission parameters 744 of either the serving or neighbor base station(s) to reduce the neighbor interference indicated in the report. In one example, when coordinating with the neighbor base station(s), the serving base station may transmit beam information 738, neighbor cell identifiers 740, or other information in the indication 734 (e.g., the measurement report 736) to the neighbor base station(s), and the neighbor base station(s) may modify one or more of the transmission parameters 744 in response to this information. In another example, when coordinating with the neighbor base station(s), the serving base station may modify one or more of the transmission parameters 744 in response to the information in indication 734, and the serving base station may inform the neighbor base station(s) of the modified transmission parameters for the neighbor base station(s) to consider in subsequent communications with the UE 702. The transmission parameters 744 modified by the serving or neighbor base station(s) may include, for example, a transmission power 746, a beam direction 748, a precoding indicator 750, a slot format configuration 752, or other parameters (e.g., a time-frequency resources).

In one example, in response to obtaining indication 734 from UE 702, the serving base station 704 may provide a grant 754 to the UE 702 modifying a time-frequency resource 756 (e.g., one or more RB(s), symbol(s), or slot(s)) for subsequent data transmissions. For instance, the grant 754 may be a PDSCH grant assigning time-frequency resources for downlink data or a PUSCH grant assigning time-frequency resources for uplink data, and the time-frequency resources may be different than the resources assigned to the UE prior to providing indication 734. Such time-frequency resources may also be mutually exclusive with other resources in which the UE 702 may receive data from neighbor base station(s) 706 in order to reduce neighbor interference from those neighbor base stations. In another example, in response to indication 734 from UE, the neighbor base station(s) may reduce a transmission power applied to subsequent data communications, or the serving base station may increase a transmission power applied to subsequent data communications, in order to reduce neighbor interference in response to indication 734 from UE 702. In other examples, in response to indication 734 from UE 702, the neighbor base station(s) or serving base station may change one or more beam directions, precoding indicators, or slot format configurations applied to subsequent data communications in order to reduce neighbor interference. The serving or neighbor base station(s) may modify any one of, or any combination of the transmission parameters 744 in response to the indication 734 when coordinating with each other at block 742. Alternatively or additionally, the serving or neighbor base station(s) may apply eICIC in response to indication 734 (e.g., the eICIC solutions 602 such as described above with respect to FIG. 6) when coordinating with each other at block 742.

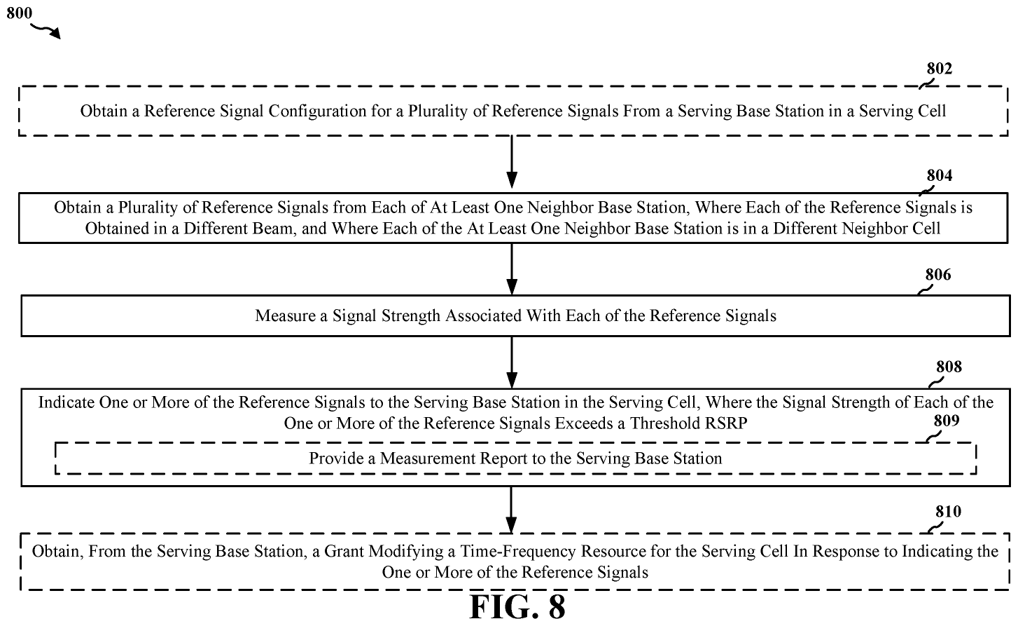

FIG. 8 is a flowchart 800 of a method of wireless communication. The method may be performed by a UE (e.g., the UE 104, 402, 702, the apparatus 1002). Optional aspects are illustrated in dashed lines. The method allows a UE to measure neighbor reference signals obtained in different beams, determine the reference signals associated with strong beam-wise neighbor interference, and to indicate these reference signals to a serving base station to allow the serving base station to coordinate with the neighbor base station(s) and reduce the neighbor interference.

At 802, the UE may obtain a reference signal configuration for a plurality of reference signals from a serving base station in a serving cell. For example, 802 may be performed by reference signal configuration component 1040. For instance, as described above with respect to FIG. 7, the UE 702 may obtain reference signal configuration 708 for reference signals 710 from serving base station 704 in a serving cell (e.g., serving cell 406). For example, referring to FIG. 3, RX processor 356 of the UE 350 may receive and demodulate data including the reference signal configuration from one or more antennas 352 via receiver 354, and the controller/processor 359 of UE 350 may obtain the demodulated data from the RX processor 356 of the UE.

In one example, the reference signals may be SSBs. For instance, as described above with respect to FIG. 7, the reference signals 710 may be SSBs 712. In one example, the reference signals may be CSI-RS. For instance, as described above with respect to FIG. 7, the reference signals 710 may be CSI-RS 714. In one example, the reference signals may be CRS. For instance, as described above with respect to FIG. 7, the reference signals 710 may be CRS 716. In one example, the reference signal configuration may include a neighbor cell identifier for each of at least one neighbor base station. For instance, as described above with respect to FIG. 7, the reference signal configuration 708 may include neighbor cell identifier(s) 718 for each of at least one neighbor base station 706 (e.g., neighbor base stations 412 in FIG. 4).

At 804, the UE obtains the plurality of reference signals from each of the at least one neighbor base station, where each of the reference signals is obtained in a different beam, and where each of the at least one neighbor base station is in a different neighbor cell. For example, 804 may be performed by reference signal component 1042. For instance, as described above with respect to FIG. 7, the UE 702 may obtain reference signals 710 from each of the neighbor base station(s) 706 (e.g., neighbor base stations 412 in FIG. 4). For example, referring to FIG. 3, RX processor 356 of the UE 350 may receive and demodulate data including the reference signals from one or more antennas 352 via receiver 354, and the controller/processor 359 of UE 350 may obtain the demodulated data from the RX processor 356 of the UE. The UE may obtain each reference signal 710 from a neighbor base station (or from multiple neighbor base stations) in a different reception beam 722, and each neighbor base station 706 may be in a different neighbor cell (e.g., neighbor cell 410).

At 806, the UE measures a signal strength associated with each of the reference signals. For example, 806 may be performed by measurement component 1044. For instance, as described above with respect to FIG. 7, at block 724, the UE may measure the signal strength 726 associated with each of the reference signals 710. For example, referring to FIG. 3, the controller/processor 359 of UE 350 may identify an RSRP of each of the reference signals 710 obtained by the controller/processor (e.g., at 804).

At 808, the UE indicates one or more of the reference signals to the serving base station in the serving cell, where the signal strength of each of the indicated one or more of the reference signals exceeds a threshold reference signal received power (RSRP). For example, 808 may be performed by indication component 1046. In one example, at 809, the UE may provide a measurement report to the serving base station, where the measurement report includes beam information associated with each of the indicated one or more of the reference signals. In a further example, the measurement report may include a neighbor cell identifier for each of the at least one neighbor base station. For instance, as described above with respect to FIG. 7, the UE 702 may indicate one or more of the reference signals 710 (i.e., reference signal(s) 732) to serving base station in the serving cell (e.g., serving cell 406 in FIG. 4). For example, the controller/processor 359 of UE 350 may send an indication 734 of reference signal(s) 732 to the serving base station 704, for example, in the form of a measurement report 736 or other message including beam information 738 associated with each of the reference signals 732. For instance, the controller/processor 359 may modulate data including the beam information in the indication (e.g., the measurement report or other message), and provide the modulated data to the TX processor 368 to be transmitted to the serving base station using one or more antennas 352. Moreover, the UE 702 may identify each of reference signal(s) 732, namely which of the reference signals 710 correspond to reference signal(s) 732, in response to determining at 728 whether the signal strength 726 of a reference signal 710 exceeds a threshold RSRP 730. For example, referring to FIG. 3, the controller/processor 359 of UE 350 may determine that the signal strength 726 of a reference signal 710 (measured at 806) exceeds the threshold RSRP 730, in which case the UE may include that reference signal 710 in the reference signal(s) 732. The UE may similarly determine multiple reference signals 710 to be included in reference signals 732 based on their respective signal strengths.

Finally, at 810, the UE may obtain, from the serving base station, a grant modifying a time-frequency resource for the serving cell in response to the indicated one or more of the reference signals. For example, 810 may be performed by grant component 1048. For instance, as described above with respect to FIG. 7, the UE 702 may obtain from serving base station 704 a grant 754 (e.g., uplink or downlink) modifying time-frequency resources 756 (e.g., one or more RBs, slots, or symbols) in response to the indication 734 of reference signal(s) 732. For example, referring to FIG. 3, RX processor 356 of the UE 350 may receive and demodulate data including the grant from one or more antennas 352 via receiver 354, and the controller/processor 359 of UE 350 may obtain the demodulated data from the RX processor 356 of the UE.

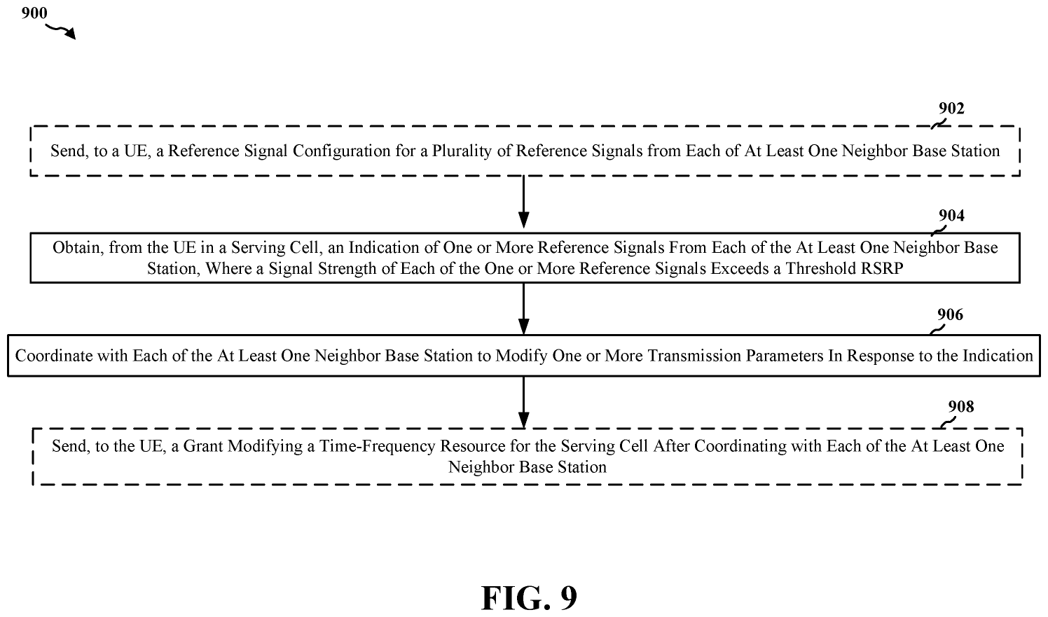

FIG. 9 is a flowchart 900 of a method of wireless communication. The method may be performed by a serving base station (e.g., the base station 102/180, 404, serving base station 704; the apparatus 1102). Optional aspects are illustrated in dashed lines. The method allows a base station serving a UE to obtain from the UE an indication of neighbor reference signals associated with strong beam-wise interference, and coordinate with the neighbor base station(s) originating those reference signals to reduce the neighbor interference.

At 902, the base station may send, to the UE, a reference signal configuration for a plurality of reference signals from each of at least one neighbor base station. For example, 902 may be performed by reference signal configuration component 1140. The reference signal configuration may include a neighbor cell identifier for each of the at least one neighbor base station. For instance, as described above with respect to FIG. 7, the serving base station 704 may send to UE 702 reference signal configuration (708 for reference signals 710 from each of the neighbor base station(s) 706. For example, the reference signal configuration may include neighbor cell identifier(s) 718 for each of the neighbor base station(s) 706.

At 904, the base station obtains, from a UE in a serving cell, an indication of one or more reference signals from each of the at least one neighbor base station, where a signal strength of each of the one or more reference signals exceeds a threshold RSRP. For example, 904 may be performed by indication component 1142. For instance, as described above with respect to FIG. 7, the serving base station 704 may obtain from UE 702 (e.g., in serving cell 406 in FIG. 4) an indication 734 of reference signal(s) 732 from each of neighbor base station(s) 706, where the signal strength 726 of each of the reference signal(s) 732 exceeds threshold RSRP 730.

In one example, the indication may be obtained in response to the reference signal configuration. For instance, as described above with respect to FIG. 7, the indication 734 may be obtained by serving base station 704 in response to the reference signal configuration(s) provided to UE 702. In various examples, the one or more reference signals may be SSBs, CSI-RS, or CRS. For instance, as described above with respect to FIG. 7, the reference signal(s) 732 may be SSBs 712, CSI-RS 714, or CRS 716. In one example, the indication may be obtained from the UE in a measurement report, where the measurement report may include beam information associated with each of the one or more reference signals. For instance, as described above with respect to FIG. 7, the indication 734 may be obtained by serving base station 704 from UE 702 in the form of measurement report 736, where measurement report 736 may include beam information 738 associated with each of the reference signal(s) 732. In one example, the measurement report may include a neighbor cell identifier for each of the at least one neighbor base station. For instance, as described above with respect to FIG. 7, the measurement report 736 may include neighbor cell identifier(s) 740 for each of the neighbor base station(s) 706.

At 906, the base station coordinates with each of the at least one neighbor base station to modify one or more transmission parameters in response to the indication. For example, 906 may be performed by coordination component 1144. The one or more transmission parameters may include a transmission power, a beam direction, a precoding indicator, or a slot format configuration. For instance, as described above with respect to FIG. 7, at block 742, the serving base station 704 may coordinate with neighbor base station(s) 706 to modify one or any combination of transmission parameters 744 (e.g., transmission power 746, beam direction 748, precoding indicator 750, or slot format configuration 752) in response to obtaining indication 734.

Finally, at 908, the base station may send, to the UE, a grant modifying a time-frequency resource for the serving cell after coordinating with each of the at least one neighbor base station. For example, 908 may be performed by grant component 1146. For instance, as described above with respect to FIG. 7, the serving base station 704 may send grant 754 modifying time-frequency resource 756 for the serving cell (e.g., serving cell 406 in FIG. 4) to UE 702 after coordinating with the neighbor base station(s) 706 at block 742.

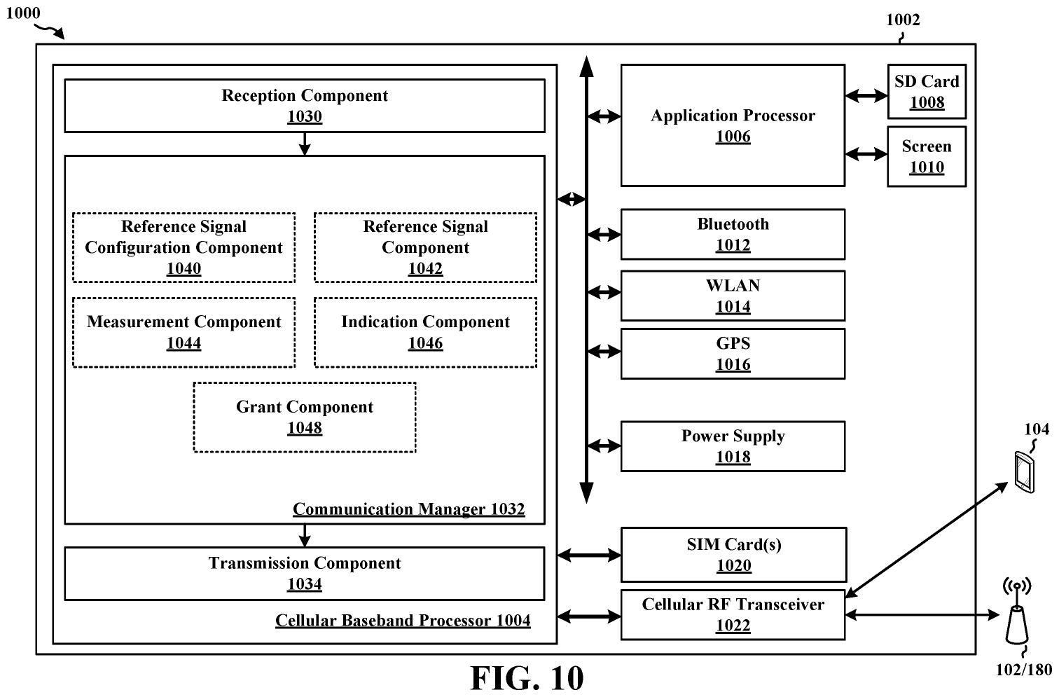

FIG. 10 is a diagram 1000 illustrating an example of a hardware implementation for an apparatus 1002. The apparatus 1002 is a UE and includes a cellular baseband processor 1004 (also referred to as a modem) coupled to a cellular RF transceiver 1022 and one or more subscriber identity modules (SIM) cards 1020, an application processor 1006 coupled to a secure digital (SD) card 1008 and a screen 1010, a Bluetooth module 1012, a wireless local area network (WLAN) module 1014, a Global Positioning System (GPS) module 1016, and a power supply 1018. The cellular baseband processor 1004 communicates through the cellular RF transceiver 1022 with the UE 104 and/or BS 102/180. The cellular baseband processor 1004 may include a computer-readable medium/memory. The computer-readable medium/memory may be non-transitory. The cellular baseband processor 1004 is responsible for general processing, including the execution of software stored on the computer-readable medium/memory. The software, when executed by the cellular baseband processor 1004, causes the cellular baseband processor 1004 to perform the various functions described supra. The computer-readable medium/memory may also be used for storing data that is manipulated by the cellular baseband processor 1004 when executing software. The cellular baseband processor 1004 further includes a reception component 1030, a communication manager 1032, and a transmission component 1034. The communication manager 1032 includes the one or more illustrated components. The components within the communication manager 1032 may be stored in the computer-readable medium/memory and/or configured as hardware within the cellular baseband processor 1004. The cellular baseband processor 1004 may be a component of the UE 350 and may include the memory 360 and/or at least one of the TX processor 368, the RX processor 356, and the controller/processor 359. In one configuration, the apparatus 1002 may be a modem chip and include just the baseband processor 1004, and in another configuration, the apparatus 1002 may be the entire UE (e.g., see 350 of FIG. 3) and include the aforediscussed additional modules of the apparatus 1002.

The communication manager 1032 includes a reference signal configuration component 1040 that is configured to obtain a reference signal configuration for the plurality of reference signals from the serving base station in the serving cell, e.g., as described in connection with 802. The communication manager 1032 further includes a reference signal component 1042 that receives input in the form of the reference signal configuration from the reference signal configuration component 1040 and is configured to obtain a plurality of reference signals from each of at least one neighbor base station, where each of the reference signals is obtained in a different beam, and where each of the at least one neighbor base station is in a different neighbor cell, e.g., as described in connection with 804. The communication manager 1032 further includes a measurement component 1044 that receives input in the form of the reference signals from the reference signal component 1042 and is configured to measure a signal strength associated with each of the reference signals, e.g., as described in connection with 806. The communication manager 1032 further includes an indication component 1046 that receives input in the form of the signal strengths from the measurement component 1044 and is configured to indicate one or more of the reference signals to a serving base station in a serving cell, where the signal strength of each of the one or more of the reference signals exceeds a threshold RSRP, e.g., as described in connection with 808. The communication manager 1032 further includes a grant component 1048 that is configured to obtain from the serving base station, a grant modifying a time-frequency resource for the serving cell in response to indicating the one or more of the reference signals, e.g., as described in connection with 810.

The apparatus may include additional components that perform each of the blocks of the algorithm in the aforementioned flowcharts of FIGS. 7 and 8. As such, each block in the aforementioned flowcharts of FIGS. 7 and 8 may be performed by a component and the apparatus may include one or more of those components. The components may be one or more hardware components specifically configured to carry out the stated processes/algorithm, implemented by a processor configured to perform the stated processes/algorithm, stored within a computer-readable medium for implementation by a processor, or some combination thereof.

In one configuration, the apparatus 1002, and in particular the cellular baseband processor 1004, includes means for obtaining a plurality of reference signals from each of at least one neighbor base station, wherein each of the reference signals is obtained in a different beam, and wherein each of the at least one neighbor base station is in a different neighbor cell; means for measuring a signal strength associated with each of the reference signals; and means for indicating one or more of the reference signals to a serving base station in a serving cell, wherein the signal strength of each of the one or more of the reference signals exceeds a threshold reference signal received power (RSRP).

In one configuration, the apparatus 1002, and in particular the cellular baseband processor 1004, may include means for obtaining a reference signal configuration for the plurality of reference signals from the serving base station in the serving cell.

In one configuration, the apparatus 1002, and in particular the cellular baseband processor 1004, may include means for obtaining, from the serving base station, a grant modifying a time-frequency resource for the serving cell in response to indicating the one or more of the reference signals.

The aforementioned means may be one or more of the aforementioned components of the apparatus 1002 configured to perform the functions recited by the aforementioned means. As described supra, the apparatus 1002 may include the TX Processor 368, the RX Processor 356, and the controller/processor 359. As such, in one configuration, the aforementioned means may be the TX Processor 368, the RX Processor 356, and the controller/processor 359 configured to perform the functions recited by the aforementioned means.

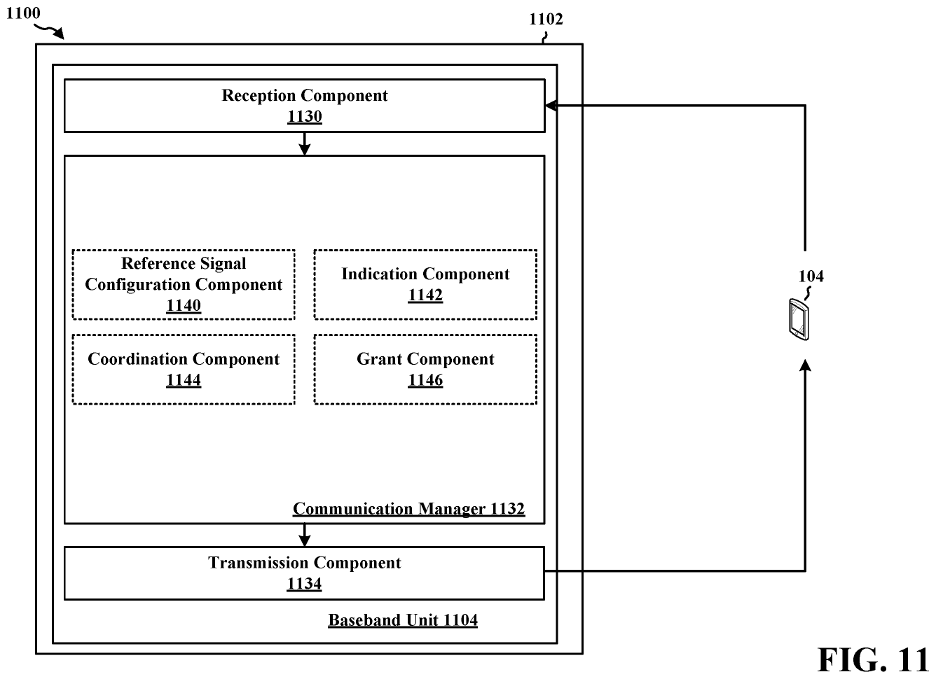

FIG. 11 is a diagram 1100 illustrating an example of a hardware implementation for an apparatus 1102. The apparatus 1102 is a BS and includes a baseband unit 1104. The baseband unit 1104 may communicate through a cellular RF transceiver with the UE 104. The baseband unit 1104 may include a computer-readable medium/memory. The baseband unit 1104 is responsible for general processing, including the execution of software stored on the computer-readable medium/memory. The software, when executed by the baseband unit 1104, causes the baseband unit 1104 to perform the various functions described supra. The computer-readable medium/memory may also be used for storing data that is manipulated by the baseband unit 1104 when executing software. The baseband unit 1104 further includes a reception component 1130, a communication manager 1132, and a transmission component 1134. The communication manager 1132 includes the one or more illustrated components. The components within the communication manager 1132 may be stored in the computer-readable medium/memory and/or configured as hardware within the baseband unit 1104. The baseband unit 1104 may be a component of the BS 310 and may include the memory 376 and/or at least one of the TX processor 316, the RX processor 370, and the controller/processor 375.

The communication manager 1132 includes a reference signal configuration component 1140 that is configured to send, to a UE, a reference signal configuration for a plurality of reference signals from each of at least one neighbor base station, e.g., as described in connection with 902 of FIG. 9. The communication manager 1132 further includes an indication component 1142 that is configured to obtain, from a UE in a serving cell, an indication of one or more reference signals from each of at least one neighbor base station, where a signal strength of each of the one or more reference signals exceeds a threshold RSRP, e.g., as described in connection with 904 of FIG. 9. The indication component 1142 may be configured to obtain the indication in response to the reference signal configuration component 1140 sending the reference signal configuration. The communication manager 1132 further includes a coordination component 1144 that is configured to coordinate with each of the at least one neighbor base station to modify one or more transmission parameters in response to the indication, e.g., as described in connection with 906 of FIG. 9. The communication manager 1132 further includes a grant component 1146 that is configured to send, to the UE, a grant modifying a time-frequency resource for the serving cell after coordinating with each of the at least one neighbor base station, e.g., as described in connection with 908 of FIG. 9.

The apparatus may include additional components that perform each of the blocks of the algorithm in the aforementioned flowcharts of FIGS. 7 and 9. As such, each block in the aforementioned flowcharts of FIGS. 7 and 9 may be performed by a component and the apparatus may include one or more of those components. The components may be one or more hardware components specifically configured to carry out the stated processes/algorithm, implemented by a processor configured to perform the stated processes/algorithm, stored within a computer-readable medium for implementation by a processor, or some combination thereof.

In one configuration, the apparatus 1102, and in particular the baseband unit 1104, includes means for obtaining, from a user equipment (UE) in a serving cell, an indication of one or more reference signals from each of at least one neighbor base station, wherein a signal strength of each of the one or more reference signals exceeds a threshold reference signal received power (RSRP); and means for coordinating with each of the at least one neighbor base station to modify one or more transmission parameters in response to the indication.

In one configuration, the apparatus 1102, and in particular the baseband unit 1104, may include means for sending, to the UE, a reference signal configuration for a plurality of reference signals from each of the at least one neighbor base station, wherein the indication is obtained in response to the reference signal configuration.

In one configuration, the apparatus 1102, and in particular the baseband unit 1104, may include means for sending, to the UE, a grant modifying a time-frequency resource for the serving cell after coordinating with each of the at least one neighbor base station.

The aforementioned means may be one or more of the aforementioned components of the apparatus 1102 configured to perform the functions recited by the aforementioned means. As described supra, the apparatus 1102 may include the TX Processor 316, the RX Processor 370, and the controller/processor 375. As such, in one configuration, the aforementioned means may be the TX Processor 316, the RX Processor 370, and the controller/processor 375 configured to perform the functions recited by the aforementioned means.

Accordingly, aspects of the present disclosure resolve the neighbor beam-wise interference which may be present in NR deployments notwithstanding eICIC. For instance, the UE may measure neighbor reference signals obtained in different beams, and indicate the reference signal(s) (or beams) associated with strong neighbor interference to a serving base station. The serving base station may then coordinate with the neighbor base station(s) to resolve the interference in response to this indication (for example, by allowing the UE to receive subsequent neighbor reference signals with less transmission power, in different beam directions, or based on different precoding indicators or slot format indicators), and reducing the neighbor interference accordingly. This process may be especially beneficial in HAPS systems, where neighbor interference may increase over time for certain beams due to base station mobility (e.g., on an aircraft, drone, etc.).

It is understood that the specific order or hierarchy of blocks in the processes/flowcharts disclosed is an illustration of example approaches. Based upon design preferences, it is understood that the specific order or hierarchy of blocks in the processes/flowcharts may be rearranged. Further, some blocks may be combined or omitted. The accompanying method claims present elements of the various blocks in a sample order, and are not meant to be limited to the specific order or hierarchy presented.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but is to be accorded the full scope consistent with the language claims, wherein reference to an element in the singular is not intended to mean “one and only one” unless specifically so stated, but rather “one or more.” Terms such as “if,” “when,” and “while” should be interpreted to mean “under the condition that” rather than imply an immediate temporal relationship or reaction. That is, these phrases, e.g., “when,” do not imply an immediate action in response to or during the occurrence of an action, but simply imply that if a condition is met then an action will occur, but without requiring a specific or immediate time constraint for the action to occur. The word “exemplary” is used herein to mean “serving as an example, instance, or illustration.” Any aspect described herein as “exemplary” is not necessarily to be construed as preferred or advantageous over other aspects. Unless specifically stated otherwise, the term “some” refers to one or more. Combinations such as “at least one of A, B, or C,” “one or more of A, B, or C,” “at least one of A, B, and C,” “one or more of A, B, and C,” and “A, B, C, or any combination thereof” include any combination of A, B, and/or C. and may include multiples of A, multiples of B, or multiples of C. Specifically, combinations such as “at least one of A, B, or C,” “one or more of A, B, or C,” “at least one of A, B, and C,” “one or more of A, B, and C,” and “A, B, C, or any combination thereof” may be A only, B only, C only, A and B. A and C. B and C. or A and B and C, where any such combinations may contain one or more member or members of A, B, or C. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. The words “module,” “mechanism,” “element,” “device,” and the like may not be a substitute for the word “means.” As such, no claim element is to be construed as a means plus function unless the element is expressly recited using the phrase “means for.”

The following examples are illustrative only and may be combined with aspects of other embodiments or teachings described herein, without limitation.

Example 1 is a method of wireless communication at a user equipment (UE), comprising: obtaining a plurality of reference signals from each of at least one neighbor base station, wherein each of the reference signals is obtained in a different beam, and wherein each of the at least one neighbor base station is in a different neighbor cell; measuring a signal strength associated with each of the reference signals; and indicating one or more of the reference signals to a serving base station in a serving cell, wherein the signal strength of each of the indicated one or more of the reference signals exceeds a threshold reference signal received power (RSRP).

Example 2 is the method of Example 1, wherein the reference signals are synchronization signal blocks (SSBs).

Example 3 is the method of Example 1, wherein the reference signals are channel state information reference signals (CSI-RSs).

Example 4 is the method of Example 1, wherein the reference signals are cell-specific reference signals (CRSs).

Example 5 is the method of any of Examples 1 to 4, further comprising: obtaining a reference signal configuration for the plurality of reference signals from the serving base station in the serving cell.

Example 6 is the method of Example 5, wherein the reference signal configuration includes a neighbor cell identifier for each of the at least one neighbor base station.

Example 7 is the method of any of Examples 1 to 6, wherein the indicating comprises: providing a measurement report to the serving base station, wherein the measurement report includes beam information associated with each of the one or more of the reference signals.

Example 8 is the method of Example 7, wherein the measurement report includes a neighbor cell identifier for each of the at least one neighbor base station.

Example 9 is the method of any of Examples 1 to 8, further comprising: obtaining, from the serving base station, a grant modifying a time-frequency resource for the serving cell in response to the indicated one or more of the reference signals.

Example 10 is an apparatus for wireless communication, comprising: a processor; memory coupled with the processor; and instructions stored in the memory and operable, when executed by the processor, to cause the apparatus to: obtain a plurality of reference signals from each of at least one neighbor base station, wherein each of the reference signals is obtained in a different beam, and wherein each of the at least one neighbor base station is in a different neighbor cell; measure a signal strength associated with each of the reference signals; and indicate one or more of the reference signals to a serving base station in a serving cell, wherein the signal strength of each of the indicated one or more of the reference signals exceeds a threshold reference signal received power (RSRP).

Example 11 is the apparatus of Example 10, wherein the instructions, when executed by the processor, further cause the apparatus to: obtain a reference signal configuration for the plurality of reference signals from the serving base station in the serving cell.

Example 12 is the apparatus of Example 11, wherein the reference signal configuration includes a neighbor cell identifier for each of the at least one neighbor base station.

Example 13 is the apparatus of any of Examples 10 to 12, wherein to indicate the one or more of the reference signals, the instructions, when executed by the processor, cause the apparatus to: provide a measurement report to the serving base station, wherein the measurement report includes beam information associated with each of the indicated one or more of the reference signals.

Example 14 is the apparatus of Example 13, wherein the measurement report includes a neighbor cell identifier for each of the at least one neighbor base station.

Example 15 is the apparatus of any of Examples 10 to 14, wherein the instructions, when executed by the processor, further cause the apparatus to: obtain, from the serving base station, a grant modifying a time-frequency resource for the serving cell in response to indicating the one or more of the reference signals.

Example 16 is a method of wireless communication at a serving base station, comprising: obtaining, from a user equipment (UE) in a serving cell, an indication of one or more reference signals from each of at least one neighbor base station, wherein a signal strength of each of the one or more reference signals exceeds a threshold reference signal received power (RSRP); and coordinating with each of the at least one neighbor base station to modify one or more transmission parameters in response to the indication.

Example 17 is the method of Example 16, wherein the one or more reference signals are synchronization signal blocks (SSBs), channel state information reference signals (CSI-RSs), or cell-specific reference signals (CRSs).

Example 18 is the method of Example 16 or 17, further comprising: sending, to the UE, a reference signal configuration for a plurality of reference signals from each of the at least one neighbor base station, wherein the indication is obtained in response to the reference signal configuration.

Example 19 is the method of Example 18, wherein the reference signal configuration includes a neighbor cell identifier for each of the at least one neighbor base station.

Example 20 is the method of any of Examples 16 to 19, wherein the indication is obtained from the UE in a measurement report, wherein the measurement report includes beam information associated with each of the one or more reference signals.

Example 21 is the method of Example 20, wherein the measurement report includes a neighbor cell identifier for each of the at least one neighbor base station.

Example 22 is the method of any of Examples 16 to 21, wherein the one or more transmission parameters include a transmission power, a beam direction, a precoding indicator, or a slot format configuration.

Example 23 is the method of any of Examples 16 to 22, further comprising: sending, to the UE, a grant modifying a time-frequency resource for the serving cell after coordinating with each of the at least one neighbor base station.

Example 24 is an apparatus for wireless communication, comprising: a processor; memory coupled with the processor; and instructions stored in the memory and operable, when executed by the processor, to cause the apparatus to: obtain, from a user equipment (UE) in a serving cell, an indication of one or more reference signals from each of at least one neighbor base station, wherein a signal strength of each of the one or more reference signals exceeds a threshold reference signal received power (RSRP); and coordinate with each of the at least one neighbor base station to modify one or more transmission parameters in response to the indication.

Example 25 is the apparatus of Example 24, wherein the instructions, when executed by the processor, further cause the apparatus to: send, to the UE, a reference signal configuration for a plurality of reference signals from each of the at least one neighbor base station, wherein the indication is obtained in response to the reference signal configuration.

Example 26 is the apparatus of Example 25, wherein the reference signal configuration includes a neighbor cell identifier for each of the at least one neighbor base station.

Example 27 is the apparatus of any of Examples 24 to 26, wherein the indication is obtained from the UE in a measurement report, wherein the measurement report includes beam information associated with each of the one or more reference signals.

Example 28 is the apparatus of Example 27, wherein the measurement report includes a neighbor cell identifier for each of the at least one neighbor base station.

Example 29 is the apparatus of any of Examples 24 to 28, wherein the one or more transmission parameters include a transmission power, a beam direction, a precoding indicator, or a slot format configuration.

Example 30 is the apparatus of any of Examples 24 to 29, wherein the instructions, when executed by the processor, further cause the apparatus to: send to the UE, a grant modifying a time-frequency resource for the serving cell after coordinating with each of the at least one neighbor base station.

What is claimed is:

1. A method of wireless communication at a user equipment (UE), comprising:
obtaining a plurality of reference signals from each of at least one neighbor base station, wherein each of the reference signals is obtained in a different beam, and wherein each of the at least one neighbor base station is in a different neighbor cell;
measuring a signal strength associated with each of the reference signals; and
indicating one or more of the reference signals to a serving base station in a serving cell, wherein the signal strength of each of the indicated one or more of the reference signals exceeds a threshold reference signal received power (RSRP).

2. The method of claim 1, wherein the reference signals are synchronization signal blocks (SSBs).

3. The method of claim 1, wherein the reference signals are channel state information reference signals (CSI-RSs).

4. The method of claim 1, wherein the reference signals are cell-specific reference signals (CRSs).

5. The method of claim 1, further comprising:
obtaining a reference signal configuration for the plurality of reference signals from the serving base station in the serving cell.

6. The method of claim 5, wherein the reference signal configuration includes a neighbor cell identifier for each of the at least one neighbor base station.

7. The method of claim 1, wherein the indicating comprises:
providing a measurement report to the serving base station, wherein the measurement report includes beam information associated with each of the indicated one or more of the reference signals.

8. The method of claim 7, wherein the measurement report includes a neighbor cell identifier for each of the at least one neighbor base station.

9. The method of claim 1, further comprising:
obtaining, from the serving base station, a grant modifying a time-frequency resource for the serving cell in response to the indicated one or more of the reference signals.

10. An apparatus for wireless communication, comprising:
a processor;
memory coupled with the processor; and
instructions stored in the memory and operable, when executed by the processor, to cause the apparatus to:
obtain a plurality of reference signals from each of at least one neighbor base station, wherein each of the reference signals is obtained in a different beam, and wherein each of the at least one neighbor base station is in a different neighbor cell;
measure a signal strength associated with each of the reference signals; and
indicate one or more of the reference signals to a serving base station in a serving cell, wherein the signal strength of each of the indicated one or more of the reference signals exceeds a threshold reference signal received power (RSRP).

11. The apparatus of claim 10, wherein the instructions, when executed by the processor, further cause the apparatus to:
obtain a reference signal configuration for the plurality of reference signals from the serving base station in the serving cell.

12. The apparatus of claim 11, wherein the reference signal configuration includes a neighbor cell identifier for each of the at least one neighbor base station.

13. The apparatus of claim 10, wherein to indicate the one or more of the reference signals, the instructions, when executed by the processor, cause the apparatus to:
provide a measurement report to the serving base station, wherein the measurement report includes beam information associated with each of the indicated one or more of the reference signals.

14. The apparatus of claim 13, wherein the measurement report includes a neighbor cell identifier for each of the at least one neighbor base station.

15. The apparatus of claim 10, wherein the instructions, when executed by the processor, further cause the apparatus to:
obtain, from the serving base station, a grant modifying a time-frequency resource for the serving cell in response to the indicated one or more of the reference signals.

16. A method of wireless communication at a serving base station, comprising:
obtaining, from a user equipment (UE) in a serving cell, an indication of one or more reference signals from each of at least one neighbor base station, wherein a signal strength of each of the one or more reference signals exceeds a threshold reference signal received power (RSRP); and
coordinating with each of the at least one neighbor base station to modify one or more transmission parameters in response to the indication.

17. The method of claim 16, wherein the one or more reference signals are synchronization signal blocks (SSBs), channel state information reference signals (CSI-RSs), or cell-specific reference signals (CRSs).

18. The method of claim 16, further comprising:
sending, to the UE, a reference signal configuration for a plurality of reference signals from each of the at least one neighbor base station, wherein the indication is obtained in response to the reference signal configuration.

19. The method of claim 18, wherein the reference signal configuration includes a neighbor cell identifier for each of the at least one neighbor base station.

20. The method of claim 16, wherein the indication is obtained from the UE in a measurement report, wherein the measurement report includes beam information associated with each of the one or more reference signals.

21. The method of claim 20, wherein the measurement report includes a neighbor cell identifier for each of the at least one neighbor base station.

22. The method of claim 16, wherein the one or more transmission parameters include a transmission power, a beam direction, a precoding indicator, or a slot format configuration.

23. The method of claim 16, further comprising:
sending, to the UE, a grant modifying a time-frequency resource for the serving cell after coordinating with each of the at least one neighbor base station.

24. An apparatus for wireless communication, comprising:
a processor;
memory coupled with the processor; and
instructions stored in the memory and operable, when executed by the processor, to cause the apparatus to:
obtain, from a user equipment (UE) in a serving cell, an indication of one or more reference signals from each of at least one neighbor base station, wherein a signal strength of each of the one or more reference signals exceeds a threshold reference signal received power (RSRP); and
coordinate with each of the at least one neighbor base station to modify one or more transmission parameters in response to the indication.

25. The apparatus of claim 24, wherein the instructions, when executed by the processor, further cause the apparatus to:
send, to the UE, a reference signal configuration for a plurality of reference signals from each of the at least one neighbor base station, wherein the indication is obtained in response to the reference signal configuration.

26. The apparatus of claim 25, wherein the reference signal configuration includes a neighbor cell identifier for each of the at least one neighbor base station.

27. The apparatus of claim 24, wherein the indication is obtained from the UE in a measurement report, wherein the measurement report includes beam information associated with each of the one or more reference signals.

28. The apparatus of claim 27, wherein the measurement report includes a neighbor cell identifier for each of the at least one neighbor base station.

29. The apparatus of claim 24, wherein the one or more transmission parameters include a transmission power, a beam direction, a precoding indicator, or a slot format configuration.

30. The apparatus of claim 24, wherein the instructions, when executed by the processor, further cause the apparatus to:
send to the UE, a grant modifying a time-frequency resource for the serving cell after coordinating with each of the at least one neighbor base station.
